(19) United States
(12) Patent Application Publication
(10) Pub. No.: US 2023/0386710 A1
(43) Pub. Date: Nov. 30, 2023

(54) COATED RARE EARTH-IRON-NITROGEN-BASED MAGNETIC POWDER, PRODUCTION METHOD THEREOF, MAGNETIC MATERIAL FOR MAGNETIC FIELD AMPLIFICATION, AND MAGNETIC MATERIAL FOR HYPER-HIGH FREQUENCY ABSORPTION

(71) Applicant: NICHIA CORPORATION, Anan-shi (JP)

(72) Inventors: Jun AKAMATSU, Tokushima-shi (JP); Satoshi ABE, Tokushima-shi (JP); Nobuyoshi IMAOKA, Anan-shi (JP); Masahiro ABE, Tokushima-shi (JP)

(73) Assignee: NICHIA CORPORATION, Anan-shi (JP)

(21) Appl. No.: 18/324,341

(22) Filed: May 26, 2023

(30) Foreign Application Priority Data
May 26, 2022 (JP) 2022-086454

(51) Int. Cl. H01F 1/055; H01F 41/02; B22F 1/145; B22F 1/142; B22F 1/16

(52) U.S. Cl. CPC H01F 1/0551; H01F 41/0253; B22F 1/145; B22F 1/142; B22F 1/16; B22F 2999/00; B22F 2301/355; B22F 2302/45; B22F 2998/10; B22F 2201/03

(57) ABSTRACT

A coated rare earth-iron-nitrogen-based magnetic powder including: a core region; a first coating portion provided outside the core region; and a second coating portion, the core region containing R, Fe, and N, where R represents at least one selected from the group consisting of Y, Ce, Pr, Nd, Gd, Tb, Dy, Ho, Er, Tm, Lu, and Sm, and if Sm is present, Sm constitutes less than 50 atm % of the total R content, the powder including, in an order from the core region, the first coating portion containing P and R, an average atomic concentration of R in the first coating portion being higher than and not higher than twice an average atomic concentration of R in the core region, and the second coating portion having average atomic concentrations of P and R lower than those in the first coating portion, respectively, and containing Fe.

### CROSS-REFERENCE TO RELATED PATENT APPLICATION

This application claims priority to Japanese Patent Application No. 2022-086454 filed on May 26, 2022. The disclosure of Japanese Patent Application No. 2022-086454 is hereby incorporated by reference in its entirety.

### BACKGROUND

The present disclosure relates to coated rare earth-iron-nitrogen-based magnetic powder, a production method thereof, a magnetic material for magnetic field amplification, and a magnetic material for hyper-high frequency absorption.

In recent years, as devices have become more compact and multifunctional and computing speeds have increased, the driving frequency has been increasing, and the use of high or hyper-high frequency based devices has grown steadily. Particularly noteworthy is the progress of power devices used in the high frequency range of at least 1 MHz but lower than 1 GHz. For example, the market for GaN electronic devices as devices for high-frequency, high-output wireless applications or for power electronics is expected to significantly grow in the future. Higher-frequency GaN circuits for power electronics require not only higher-frequency GaN devices but also higher-frequency passive components. For example, GaN contactless power transfer uses a frequency of higher than 10 MHz and needs coils including magnetic core materials that can follow high frequencies. At present, however, due to the lack of magnetic core materials with excellent high-frequency characteristics, there is no choice but to use air-core coils, which disadvantageously increase the overall circuit size, even if devices can be downsized by using GaN for higher frequency applications.

Also noteworthy is the progress of information infrastructures in the hyper-high frequency range of 1 GHz to 1 THz. There are various needs for high-frequency characteristics of materials which can absorb signals in the frequency range of at least 1 GHz but lower than 10 GHz for 5G, of at least 10 GHz but lower than 100 GHz for 5G plus, or of at least 100 GHz but not higher than 1 THz for 6G, and their harmonics and other spurious signals. These needs have recently been increasing. Particularly, no material currently exists that can absorb a wide range of hyper-high frequencies of at least 1 GHz or even at least 10 GHz, and there is a great demand for the development of very broad frequency band hyper-high frequency absorbing materials which can be widely used in the frequency range of at least 1 GHz but not higher than 1 THz. High frequency magnetic materials that have been known so far include a rare earth-iron-nitrogen-based magnetic material including powder having a surface coated with a ferrite-based magnetic material (WO2008/136391).

### SUMMARY

However, the material disclosed in WO 2008/136391 is not efficient enough to be applied to materials for magnetic field amplification in a frequency range of at least 1 MHz but not higher than 1 THz as described above. Another problem is that the material does not have high-frequency characteristics which can meet the needs of very broad frequency band absorbing materials in the hyper-high frequency range.

Certain embodiments of the present disclosure aim to provide a magnetic powder having excellent high-frequency characteristics with low iron loss and excellent efficiency even at high frequencies, and a method of producing the magnetic powder.

Exemplary embodiments of the present disclosure relate to a coated rare earth-iron-nitrogen-based magnetic powder, including: a core region; a first coating portion provided outside the core region; and a second coating portion, the core region containing R, Fe, and N, where R represents at least one selected from the group consisting of Y, Ce, Pr, Nd, Gd, Tb, Dy, Ho, Er, Tm, Lu, and Sm, and if Sm is present, Sm constitutes less than 50 atm % of a total R content, the magnetic powder including, in an order from the core region, the first coating portion containing P and R, an average atomic concentration of R in the first coating portion being higher than an average atomic concentration of R in the core region, and the average atomic concentration of R in the first coating portion being not higher than twice the average atomic concentration of R in the core region, and the second coating portion having average atomic concentrations of P and R lower than average atomic concentrations of P and R, respectively, in the first coating portion and containing Fe.

Additionally, exemplary embodiments of the present disclosure relate to a method of producing magnetic powder, the method including a phosphorus treatment including adding an inorganic acid to a slurry containing: a rare earth-iron-nitrogen-based magnetic powder containing R, Fe, and N, where R represents at least one selected from the group consisting of Y, Ce, Pr, Nd, Gd, Tb, Dy, Ho, Er, Tm, Lu, and Sm, and if Sm is present, Sm constitutes less than 50 atm % of a total R content; water; and a phosphorus-containing substance, to form a phosphorus compound coating portion on the rare earth-iron-nitrogen-based magnetic powder, and heat-treating the rare earth-iron-nitrogen-based magnetic powder having the phosphorus compound coating portion at a temperature of at least 180° C. but not higher than 350° C. in an oxygen-containing atmosphere.

The above embodiments can provide a magnetic powder having excellent high-frequency characteristics with low iron loss and excellent efficiency even at high frequencies, and a method of producing the magnetic powder.

### BRIEF DESCRIPTION OF DRAWINGS

FIG. 1A shows a STEM image of a cross-section of a magnetic powder prepared in Comparative Example 1.

FIG. 1B shows the line-scan results of a surface of the magnetic powder prepared in Comparative Example 1.

FIG. 2A shows a STEM image of a cross-section of a magnetic powder prepared in Reference Example 1.

FIG. 2B shows the line-scan results of a surface of the magnetic powder prepared in Reference Example 1.

FIG. 3A shows a STEM image of a cross-section of a magnetic powder prepared in Example 1.

FIG. 3B shows the line-scan results of a surface of the magnetic powder prepared in Example 1.

FIG. 4A shows a STEM image of a cross-section of a magnetic powder prepared in Example 2.

FIG. 4B shows the line-scan results of a surface of the magnetic powder prepared in Example 2.

FIG. 4C shows an enlarged view of the white rectangular part in the STEM image of the magnetic powder prepared in Example 2 shown in FIG. 4A.

FIG. 4D shows an X-ray image of Fe properties of the white rectangular part in the STEM image of the magnetic powder prepared in Example 2 shown in FIG. 4A.

### DETAILED DESCRIPTION

Embodiments of the present disclosure are described in detail below. The following embodiments, however, are intended as examples to embody the technical idea of the present disclosure and are not intended to limit the scope of the present disclosure to the following embodiments. As used herein, the term “step” encompasses not only an independent step but also a step that may not be clearly distinguished from other steps, as long as a desired object of the step is achieved. Moreover, numerical ranges indicated using “to” refer to ranges including the numerical values before and after “to” as the minimum and maximum, respectively.

Herein, the term “high frequency” refers to electromagnetic waves with high frequencies. In this disclosure, the term refers to electromagnetic waves of at least 1 MHz but lower than 1 GHz, unless otherwise stated. Moreover, the term “hyper-high frequency” refers to electromagnetic waves with higher frequencies (at least 1 GHz but not higher than 1 THz) than “high frequency”.

As used herein, the term “excellent efficiency” means that the ratio of the imaginary part (μ) to the real part (μ) of the complex relative permeability (μ, i.e., tan δ (also called loss factor), of the magnetic material at a given frequency f is small. Herein, δ, which is called the phase difference, is in the range of 0° to 90°. Thus, since tan δ is a monotonically increasing function with respect to δ, the term “excellent efficiency” can be considered as a small δ value. Moreover, the value of (90°-δ) is called the phase angle θ, and herein it is in the range of 90° to 0°. Thus, the term “excellent efficiency” can be considered as a large θ value closer to 90°, contrary to δ. Magnetic materials with a small tan δ and a small δ or with a large θ closer to 90° may be used to amplify electromagnetic waves at a given frequency f while reducing their loss. When the high-frequency characteristic values tan δ, δ, and θ become “excellent efficiency” in a frequency range excluding the hyper-high frequency range, these high-frequency characteristic values are regarded as “improved”. In contrast, when tan δ and δ are increased or θ is reduced to a value farther from 90° in a frequency range excluding the hyper-high frequency range, these high-frequency characteristic values are regarded as “deteriorated”.

As used herein, “magnetic field amplification” characteristics refer to characteristics in which the real part (μ′) of the complex relative permeability of the magnetic material is higher than the real part (=1) of the relative permeability of vacuum, and the magnetic field in the space where the magnetic material is placed is increased as compared to the magnetic field in vacuum (or in the atmosphere). Good or high magnetic field amplification characteristics mean high μ′. Materials with μ′ values exceeding 2 at a given frequency f are referred to as “magnetic materials for magnetic field amplification” at the frequency f. The term “relative permeability” when used alone is a general term for the absolute values of the real part and the imaginary part of the complex relative permeability. High relative permeability means that the real part of the relative permeability is high, unless otherwise stated.

As used herein, “hyper-high frequency absorption” characteristics refer to high-frequency characteristics in a hyper-high frequency range and mean characteristics in which the imaginary part (μ) of the complex relative permeability of the magnetic material in a hyper-high frequency range is larger than 0, and high frequencies incident to the space where the magnetic material is placed are attenuated. Good or high hyper-high frequency absorption characteristics at a given frequency mean high μ″ at the frequency. Materials with μ values exceeding 0 in a hyper-high frequency range are referred to as “magnetic materials for hyper-high frequency absorption”. For magnetic materials for hyper-high frequency absorption only, higher μ″ and lower μ″ may also be referred to as improved μ″ and deteriorated μ″, respectively. Moreover, both the magnetic field amplification characteristics in a high frequency range and the high-frequency absorption characteristics in a hyper-high frequency range are collectively referred to as high-frequency characteristics.

### Coated Rare Earth-Iron-Nitrogen-Based Magnetic Powder

A coated rare earth-iron-nitrogen-based magnetic powder according to the present embodiments includes a core region, a first coating portion provided outside the core region, and a second coating portion, wherein the core region contains R, Fe, and N, where R represents at least one selected from the group consisting of Y, Ce, PR, Nd, Gd, Tb, Dy, Ho, Er, Tm, Lu, and Sm, and if Sm is present, Sm constitutes less than 50 atm % of the total R content, and the magnetic powder includes, in an order from the core region, the first coating portion containing P and R, an average atomic concentration of R in the first coating portion being higher than an average atomic concentration of R in the core region, and the average atomic concentration of R in the first coating portion being not higher than twice the average atomic concentration of R in the core region, and the second coating portion having average atomic concentrations of P and R lower than the average atomic concentrations of P and R, respectively, in the first coating portion and containing Fe.

### Core Region

The core region includes a rare earth-iron-nitrogen-based material. Specifically, it contains at least one rare earth R, Fe, and N, where R represents at least one selected from the group consisting of Y, Ce, Pr, Nd, Gd, Tb, Dy, Ho, Er, Tm, Lu, and Sm, and if Sm is present, Sm constitutes less than 50 atm % of the total R content. The core region may be a nitride having a Th₂Zn₁₇-type crystal structure and containing R, iron (Fe), and nitrogen (N), where R represents at least one selected from Y, Ce, Pr, Nd, Gd, Tb, Dy, Ho, Er, Tm, Lu, and Sm, and if Sm is present, Sm constitutes less than 50 atm % of the total R content, as represented by the general formula: RₓFe_{100-x-y}N_{y}, preferably wherein x is at least 3 but not more than 30; y is at least 10 but not more than 30; and the balance is mainly Fe. If Sm is present, Sm constitutes less than 50 atm %, preferably less than 20 atm % of the total R content.

The average particle size of the core region is preferably at least 0.1 μm but not more than 100 μm, more preferably at least 0.1 μm but not more than 60 μm, still more preferably at least 1 μm but not more than 30 μm.

The average atomic concentration of R in the core region is preferably at least 3 atm % but not more than 30 atm %, more preferably at least 5 atm % but not more than atm %. The average atomic concentration (atm %) of R in the core region can be determined by averaging the atomic concentrations (atm %) at each point in the region measured in a STEM-EDX line scan. Also herein, the average atomic concentrations of other elements also each refer to the average of the atomic concentrations in the corresponding region, unless otherwise stated. Here, the average atomic concentration of R in the core region is determined in the core region that is before the point at which the R concentration greatly changes toward the first coating portion. For example, it is determined from the atomic concentrations of R in an about 10-15 nm region of the surface on the first coating portion side of the core region, in which the atomic concentration of R is less than 1.3 times the average atomic concentration of R in the core region to be determined.

The rare earth-iron-nitrogen-based magnetic powder included in the core region may be produced by any method. Exemplary production methods are described in detail below.

### Solid Phase Method

A method of producing rare earth-iron-nitrogen-based magnetic powder according to a solid phase method includes:
mixing R oxide powder, a Fe raw material, and Ca powder (mixing step);
reducing the resulting mixture (reduction step); and
nitriding alloy particles obtained in the reduction step (nitridation step).

### Mixing Step

Not only metallic Fe but also Fe₂O₃ and/or Fe₃O₄ can be used as the Fe raw material in the mixing step. The amount of Fe₂O₃ and/or Fe₃O₄, if used (the total number of moles of Fe in Fe₂O₃ and/or Fe₃O₄ relative to the total number of moles of Fe in metallic Fe and Fe₂O₃ and/or Fe₃O₄) is preferably not more than 30 atm %. The reaction heat generated when the iron oxides are reduced by Ca may allow the overall reaction to uniformly proceed, thereby saving the external energy and enhancing the yield. The amount of granular Ca mixed needs to be enough to reduce the R oxide and the selectively mixed metal oxide(s). The amount of granular Ca may be at least 0.5 times but not more than three times, preferably at least one time but not more than two times the equivalent amount of oxygen atoms in the R oxide and selectively mixed Fe₂O₃ and/or Fe₃O₄.

### Reduction Step

The powder mixture obtained in the mixing step may be placed in a heating vessel which can be vacuum-evacuated. After vacuum evacuation of the heating vessel, the powder mixture may be heated at a temperature of at least 600° C. but not higher than 1300° C., preferably at least 700° C. but not higher than 1200° C., more preferably at least 800° C. but not higher than 1100° C. while passing argon gas therethrough. If the heating temperature is lower than 600° C., the reduction reaction of the oxide may not proceed. If the heating temperature is higher than 1300° C., the rare earth and Fe may melt into bulk form. Moreover, when the heating temperature is at least 700° C., the reduction time tends to be shortened, resulting in improved productivity. When the heating temperature is not higher than 1200° C., scattering of Ca tends to be reduced, resulting in further reduced variations during the reduction. To more uniformly perform the reduction reaction, the heat treatment time may be not longer than four hours, preferably shorter than 120 minutes, more preferably shorter than 90 minutes. The lower limit of the heat treatment time is preferably at least 10 minutes, more preferably at least 30 minutes. Here, when the powder mixture contains an appropriate amount of Fe₂O₃ and/or Fe₃O₄ in addition to metallic Fe, they can self-heat during the temperature rise, so that a uniform reaction can proceed efficiently. However, if metallic Fe is mixed with Fe₂O₃ and/or Fe₃O₄ in an amount, calculated as elementary Fe, that exceeds 30 atm % as described in the mixing step, explosion or scattering may occur due to extremely high heat generation. Moreover, the particle size of the resulting rare earth-iron-nitrogen-based magnetic powder may be controlled by controlling the reduction temperature. Generally, the higher the reduction temperature, the larger the powder particle size.

### Nitridation Step

Cooling may be performed in argon gas to a temperature range of preferably at least 250° C. but not higher than 800° C., more preferably at least 300° C. but not higher than 600° C. To increase the reaction efficiency by reducing decomposition of the nitridation reaction product in the later stage of the nitridation step, the temperature is still more preferably lowered to a temperature range of at least 400° C. but not higher than 550° C. Subsequently, the heating vessel may be again vacuum-evacuated and then nitrogen gas may be introduced thereinto. The gas to be introduced is not limited to nitrogen and may be nitrogen atom-containing gas such as ammonia. The contents may be heated for several hours, suitably for about five hours, while passing nitrogen gas therethrough at atmospheric pressure or higher, and then the heating may be stopped and allowed to cool.

The product obtained after the nitridation step may contain, in addition to the rare earth-iron-nitrogen-based magnetic powder, materials such as by-product CaO and unreacted metal calcium, which may be combined into sintered bulk form. In this case, a water washing step may be performed in which the product may be introduced into ion exchange water to separate calcium oxide (CaO) and other calcium-containing components as a calcium hydroxide (Ca(OH)₂) suspension from the magnet powder. In the water washing step, stirring in water, standing still, and supernatant removal may be repeated several times. Further, the residual calcium hydroxide may be sufficiently removed by washing the magnetic powder with acetic acid or the like. The water washing step is preferably performed after the heat treatment in a nitrogen atmosphere because the residual unreacted Ca can be converted into calcium nitride (Ca₃N₂), which is easy to remove. The rare earth-iron-nitrogen-based magnetic powder obtained as above tends to have a sharper particle size distribution.

### Precipitation Method

A method of producing rare earth-iron-nitrogen-based magnetic powder according to a precipitation method includes:
mixing a solution containing R and Fe with a precipitant to obtain a precipitate containing R and Fe (precipitation step);
firing the precipitate to obtain an oxide containing R and Fe (oxidation step);
heat-treating the oxide in a reducing gas-containing atmosphere to obtain a partial oxide (pretreatment step);
reducing the partial oxide (reduction step); and
nitriding alloy particles obtained in the reduction step (nitridation step).

### Precipitation Step

In the precipitation step, a R raw material and a Fe raw material may be dissolved in a strong acid solution to prepare a solution containing R and Fe. Any R or Fe raw material which can be dissolved in a strong acid solution may be used. In view of availability, examples of the R raw material include R oxides, and examples of the Fe raw material include iron sulfate (FeSO₄). The concentration of the solution containing R and Fe may be appropriately adjusted within a range in which the R raw material and the Fe raw material can be substantially dissolved in the acid solution. In view of solubility, the acid solution may include sulfuric acid.

The solution containing R and Fe may be reacted with a precipitant to obtain an insoluble precipitate containing R and Fe. Here, the solution containing R and Fe may be such that the solution contains R and Fe at the time of the reaction with a precipitant. For example, separate solutions containing a R raw material and a Fe raw material, respectively, may be prepared and dropwise added to be reacted with a precipitant. When separate solutions are prepared, the solutions may also be appropriately adjusted within a range in which the respective raw materials can be substantially dissolved in the acid solution. The precipitant may be any alkaline solution that can react with the solution containing R and Fe to give a precipitate. Examples include an aqueous ammonia solution and caustic soda, with caustic soda being preferred.

After separating the precipitate, the separated precipitate is preferably subjected to desolvation in order to inhibit changes in particle size distribution, powder particle size, or other properties and aggregation of the precipitate upon evaporation of the solvent caused when the precipitate is re-dissolved in the remaining solvent during the heat treatment in the subsequent oxidation step. Specifically, when the solvent used is water, for example, the desolvation may be carried out by drying in an oven at a temperature of at least 70° C. but not higher than 200° C. for at least five hours but not longer than 12 hours.

The precipitation step may be followed by separating and washing the precipitate. The washing step may be appropriately performed until the conductivity of the supernatant solution reaches 5 mS/m or less. The step of separating the precipitate may be carried out, for example, by mixing the precipitate with a solvent (preferably water) and subjecting the mixture to filtering, decantation, or other separation processes.

### Oxidation Step

In the oxidation step, the precipitate formed in the precipitation step may be fired to obtain an oxide containing R and Fe. For example, the precipitate may be converted into an oxide by heat treatment. The heat treatment of the precipitate needs to be performed in the presence of oxygen, for example in an air atmosphere. Moreover, since the presence of oxygen is necessary, the non-metal portion of the precipitate preferably contains an oxygen atom. The heat treatment temperature in the oxidation step (hereinafter, oxidation temperature) is not limited, but it is preferably at least 700° C. but not higher than 1300° C., more preferably at least 900° C. but not higher than 1200° C. If the oxidation temperature is lower than 700° C., the oxidation tends to be insufficient. If the oxidation temperature is higher than 1300° C., the resulting rare earth-iron-nitrogen-based magnetic powder tends not to provide the desired shape, average particle size, or particle size distribution. The heat treatment time is not limited either and may be at least 0.5 hours but not longer than four hours, preferably at least one hour but not longer than three hours.

### Pretreatment Step

In the pretreatment step, the oxide containing R and Fe may be heat-treated in a reducing gas-containing atmosphere to obtain a partial oxide which is a partially reduced oxide.

### Reduction Step

In the reduction step, the partial oxide may be heated in the presence of a reducing agent at a temperature of at least 600° C. but not higher than 1300° C., preferably at least 700° C. but not higher than 1200° C., more preferably at least 800° C. but not higher than 1100° C. If the heating temperature is lower than 600° C., the reduction reaction of the oxide may not proceed. If the heating temperature is higher than 1300° C., R and Fe may melt into bulk form. Moreover, when the heating temperature is at least 700° C., the reduction time tends to be shortened, resulting in improved productivity. When the heating temperature is not higher than 1200° C., scattering of the reducing agent Ca tends to be reduced, resulting in further reduced variations during the reduction. The particle size of the rare earth-iron-nitrogen-based magnetic powder may be controlled by controlling the reduction temperature. Generally, the higher the reduction temperature, the larger the powder particle size. To more uniformly perform the reduction reaction, the heat treatment time is preferably shorter than 120 minutes, more preferably shorter than 90 minutes. The lower limit of the heat treatment time is preferably at least 10 minutes, more preferably at least 30 minutes.

### Nitridation Step

In the nitridation step, the alloy particles obtained in the reduction step may be nitrided to obtain anisotropic magnetic particles. Since the alloy particles obtained in the reduction step are in porous bulk form due to the use of the particulate precipitate obtained in the precipitation step described above, they can be immediately nitrided by heat treatment in a nitrogen atmosphere without grinding, thereby resulting in uniform nitridation.

The heat treatment temperature in the nitridation of the alloy particles (hereinafter, nitridation temperature) is preferably at least 250° C. but not higher than 800° C., more preferably at least 300° C. but not higher than 600° C. Moreover, to increase the reaction efficiency by reducing decomposition of the nitridation reaction product in the later stage of the nitridation step, the nitridation is particularly preferably performed within a temperature range of at least 400° C. but not higher than 550° C. in an atmosphere substituted with nitrogen. The heat treatment time may be selected so that the alloy particles can be sufficiently uniformly nitrided.

### First Coating Portion

The coated rare earth-iron-nitrogen-based magnetic powder includes a first coating portion which is provided outside the core region, contains P and R, has an average atomic concentration of R higher than an average atomic concentration of R in the core region, and has the average atomic concentration of R not higher than twice the average atomic concentration of R in the core region.

To improve the tan δ and phase angle θ of the magnetic material in a high frequency range as well as the μ″ in a hyper-high frequency range, the thickness of the first coating portion is preferably at least 1 nm but not more than 200 nm, more preferably at least 2 nm but not more than 100 nm, still more preferably at least 5 nm but not more than 80 nm, particularly preferably at least 10 nm but not more than 60 nm. Here, the thickness of the coating portion can be measured by a composition analysis of a cross-section of the coated rare earth-iron-nitrogen-based magnetic powder using a line scan or area scan of a TEM (transmission electron microscopy, STEM, or FE-SEM image by energy dispersive X-ray analysis (EDX), or a point scan with sufficient measurement points. In the measurement using a line scan, etc., for example, a region where the observed atomic concentration of phosphorus (P) is at least 1 atm % may be regarded as the first coating portion. Typical examples of ideal powder microstructures with excellent high-frequency characteristics according to the present embodiments include a structure in which the first coating portion covers the entire surface (surface coverage 100%) of the rare earth-iron-nitrogen-based magnetic powder. In this case, electrical insulation between the adjacent magnetic particles has been found to be completely maintained. In other words, this structure has an effect of reducing iron loss due to inter-particle eddy currents by the first coating portion and can further improve the tan δ and phase angle θ in a high frequency range to provide a more efficient magnetic material for magnetic field amplification. Moreover, it can reduce the influence of eddy currents in a frequency range up to a hyper-high frequency range to provide a magnetic material for hyper-high frequency absorption that maintains higher hyper-high frequency absorption characteristics. Here, the first coating portion may not completely cover the surface of the core region, and a surface coverage of at least 10% is expected to have the eddy current reducing effect to some degree. The desired surface coverage is preferably at least 50%, more preferably at least 80%. At a surface coverage of at least 10% but less than 80%, a free phosphorus compound is preferably present between the particles of the magnetic powder. The surface coverage with the first coating portion of the magnetic powder can be estimated by observing a cross-section of the powder using TEM, STEM, or FE-SEM equipped with EDX. Here, the ratio of the length of the contact portion of the phosphorus-containing coat to the entire circumferential length of the surface portion of the rare earth-iron-nitrogen-based magnetic powder observed is defined as “surface coverage”. Then, preferably cross-sections of 20 to 50 particles of the magnetic powder in an image observed as described above are measured and averaged, and the average value is taken as the surface coverage.

The first coating portion contains P and R, has an average atomic concentration of R higher than an average atomic concentration of R in the core region, and has the average atomic concentration of R not higher than twice the average atomic concentration of R in the core region. Specific examples of the form of P (phosphorus) include inorganic phosphoric acids such as orthophosphoric acid, pyrophosphoric acid, and polyphosphoric acid; phosphate compounds such as phosphates formed between these inorganic phosphoric acids and components such as Na, Ca, Pb, Zn, R, Mo, W, V, and Cr (herein, these metal elements are referred to as M components and may also be denoted simply as M), and ammonium; and “phosphorus-containing amorphous compounds” and “phosphorus-containing crystalline compounds” which contain at least one selected from R, Fe, M, and N and a phosphorus-containing substance. The phosphorus-containing crystalline compounds may be in the form of a eutectic or mixed crystal containing a rare earth phosphate or a rare earth phosphate and at least one of an iron phosphate and a M phosphate. Among these, phosphates, “phosphorus-containing amorphous compounds”, and “phosphorus-containing crystalline compounds” are preferred, e.g., from the standpoint of forming a dense surface coating portion on the powder formed from the core region. The presence of a “phosphorus-containing crystalline compound” provides better thermal stability, so that the high-frequency characteristics of the magnetic powder after the phosphorus treatment tend not to deteriorate readily even when the magnetic powder undergoes a kneading step or heat-curing step in which high heat is applied. This can contribute to high thermal stability. Moreover, when the coating portion contains a “phosphorus-containing crystalline compound”, the coating portion is less likely to be lost during the formation of a magnetic material from the magnetic powder. Thus, the resulting magnetic material may have higher electrical insulation between the particles of the magnetic powder and better efficiency. Moreover, when the “phosphorus-containing crystalline compound” is a phosphorus-containing nanocrystalline compound, the above-described advantageous effect may be further increased due to the denser coating portion. Here, the term “nanocrystal” refers to a fine crystal of at least 1 nm but less than 1 μm. Phosphorus compounds containing fine crystals of less than 1 nm are considered to fall into amorphous compounds. The crystallinity of the first coating portion and the diameter of the fine crystals in the first coating portion can be determined by lattice image observation using a TEM method or by analysis using an electron diffraction (ED) device attached to a TEM device.

The average atomic concentration of P in the first coating portion is preferably at least 1 atm % but not more than 50 atm %, more preferably at least 5 atm % but not more than 40 atm %. The average atomic concentration of P in the first coating portion can be measured by a TEM-EDX method.

The average atomic concentration of R in the first coating portion is preferably at least 1 atm % but not more than 50 atm %, more preferably at least 5 atm % but not more than 50 atm %, still more preferably at least 5 atm % but not more than 30 atm %.

In the first coating portion present on the surface of the rare earth-iron-nitrogen-based magnetic powder, the average atomic concentration of the rare earth R is higher than the average atomic concentration of R in the base material rare earth-iron-nitrogen-based magnetic powder (core region), and the average atomic concentration of R is not higher than twice the average atomic concentration of R in the core region. The average atomic concentration of R in the first coating portion is higher than the average atomic concentration of R in the core region and is preferably at least 1.05 times, more preferably at least 1.1 times, still more preferably at least 1.15 times, particularly preferably at least 1.2 times the average atomic concentration of R in the core region. Moreover, the average atomic concentration of R in the first coating portion is not more than twice, preferably not more than 1.9 times, more preferably not more than 1.8 times the average atomic concentration of R in the core region. Here, the first coating portion is a region of the coated rare earth-iron-nitrogen-based magnetic powder which has the average atomic concentration of R higher than the average atomic concentration of R in the core region as measured by a STEM-EDX method and which includes a layer showing the maximum phosphorus (P) peak. When the average atomic concentration of R in the first coating portion is within the above range relative to the average atomic concentration of R in the core region, the crystallinity in the first coating portion tends to be further improved, resulting in more homogeneous P and R atomic compositions. As a result, the thermal stability and durability of the first coating portion may be improved, and a magnetic material including the above magnetic powder having the first coating portion may have higher electrical resistivity and improved tan δ and phase angle θ. The atomic concentrations (atm %) of the elements in the first coating portion can be determined by a STEM-EDX method. The rare earth element R may be Nd, for example.

The atomic concentration ratio of R to Fe, R/Fe, in the first coating portion may be at least 0.15, preferably at least 0.3, more preferably at least 0.5. The upper limit of the R/Fe ratio in the first coating portion may be not higher than 8, not higher than 5, or not higher than 2. The R/Fe ratio in the first coating portion may also be higher than the R/Fe ratio in the core region. The R/Fe ratio in the first coating portion may be at least 1.28 times, preferably at least 2.55 times, more preferably at least 4.25 times, still more preferably at least 5 times the R/Fe ratio in the core region. When the R/Fe ratio in the first coating portion is within the above range, the atomic concentration of Fe near the core region tends to be lowered to further improve water resistance.

Moreover, the first coating portion preferably has small variations in the composition of each atom selected from O, Fe, Nd, P, and R within the region. In this case, the crystallinity in the first coating portion tends to be improved, resulting in more homogeneous P and R atomic compositions. For example, this may be confirmed by an EDX line scan across the first coating portion in which continuous measurements are performed in steps of 0.1 to 0.3 nm. The first coating portion including the above-described structure tends to provide improved stability.

Here, the compositional variations in the first coating portion may be determined as described below, for example. An EDX line scan may be performed in steps of 0.1 to 0.3 nm in the first coating portion. The polygonal line obtained as the line scan results may be divided into 1 nm sections, and the opposite end points of each section may be connected to each other to form a new line segment. As the new line segments adjacent to each other are connected to each other, a polygonal line for determination of compositional variations may be obtained. When the values of the maximum and minimum points on the polygonal line for determination of compositional variations are taken as the maximum and minimum values, respectively, if the number of pairs of the maximum and minimum values adjacent to each other is not more than one, the compositional variations may be regarded to be small.

Moreover, the first coating portion may contain a Fe-rich region. The Fe-rich region may be observed as an isolated island region in a STEM cross-sectional image. The Fe-rich region preferably has a diameter of at least 1 nm but not more than 20 nm, more preferably at least 2 nm but not more than 15 nm, as observed in a STEM cross-sectional image. The percentage of the area of the Fe-rich region relative to the area of the first coating portion determined in a STEM cross-sectional image is preferably at least 1% but not more than 50%, more preferably at least 1% but not more than 30%. In the Fe-rich region, at least the atomic concentration of Fe is higher than the average atomic concentration of Fe in the first coating portion. This is believed to be due to the separation of an iron component when the first coating portion undergoes a transition from a eutectic or mixed crystal of a rare earth phosphate and an iron phosphate and/or a M phosphate to a single phase of the rare earth phosphate during the oxidation step after phosphorus treatment. The Fe-rich region which is weak ferromagnetism like hematite or ferromagnetism like ferrite is preferred as it may serve as a region capable of promoting magnetic connection between the core regions of the particles to reduce the demagnetizing field, thereby improving the and the phase angle θ. This region is often dotted as island-like structures in the first coating portion. Here, the Fe-rich region may have the same composition as that of the second coating portion described later.

In the first coating portion, the average atomic concentration of oxygen (O) is preferably at least 0.5 times but not more than five times, more preferably at least one time but not more than four times the average atomic concentration of Fe.

The coated rare earth-iron-nitrogen-based magnetic powder may further include a Mo-rich layer. In the Mo-rich layer, the Mo added in the phosphorus treatment is present at a higher concentration than in the first coating portion. The Mo-rich layer is preferably present outside the core region, more preferably between the core region and the first coating portion and/or between the first coating portion and the second coating portion. The presence of the Mo-rich layer provides an effect of further increasing the oxidation resistance of the coated rare earth-iron-nitrogen-based magnetic powder.

The thickness of the Mo-rich layer is preferably at least 0% but not more than 100%, more preferably at least 0.0001% but not more than 10% of the average particle size of the core region. The thickness of the Mo-rich layer is also preferably at least 1 nm but not more than 100 nm, more preferably at least 2 nm but not more than 20 nm.

The atomic concentration of Mo in the Mo-rich layer is preferably at least 0.5 atm % but not more than 30 atm %, more preferably at least 1 atm % but not more than 20 atm %. The atomic concentration of Mo can be determined by averaging the atomic concentrations (atm %) in the Mo-rich region measured in a STEM-EDX line scan.

### Second Coating Portion

The coated rare earth-iron-nitrogen-based magnetic powder includes a second coating portion that has average atomic concentrations of P and the rare earth R lower than the respective average atomic concentrations in the first coating portion and contains Fe. The second coating portion is present outside the first coating portion. Thus, the coated rare earth-iron-nitrogen-based magnetic powder includes the first coating portion and the second coating portion in this order on the outside of the core region.

The average atomic concentration of P in the second coating portion is lower than that in the first coating portion. The average atomic concentration of P in the second coating portion is preferably not more than 0.99 times, more preferably not more than 0.9 times, still more preferably not more than 0.8 times the average atomic concentration of P in the first coating portion. The average atomic concentration of P in the second coating portion may be at least 0.01 times, preferably at least 0.1 times the average atomic concentration of P in the first coating portion. When the relationship between the average atomic concentration of P in the second coating portion and the average atomic concentration of P in the first coating portion satisfies the above range, the electrically insulating effect in the first coating portion tends to be more stably improved.

The average atomic concentration of P in the second coating portion is preferably not more than 49.5 atm %, more preferably not more than 39.6 atm %, still more preferably not more than 25 atm %, particularly preferably not more than 15 atm %. The average atomic concentration of P in the second coating portion may be at least 0.99 atm %.

The average atomic concentration of R in the second coating portion is lower than that in the first coating portion. The average atomic concentration of R in the second coating portion is preferably not more than 0.99 times, more preferably not more than 0.9 times, still more preferably not more than 0.8 times the average atomic concentration of R in the first coating portion. The average atomic concentration of R in the second coating portion may be at least 0.01 times, preferably at least 0.1 times the average atomic concentration of R in the first coating portion. When the relationship between the average atomic concentration of R in the second coating portion and the average atomic concentration of R in the first coating portion satisfies the above range, the second coating portion can be formed during the formation of the first coating portion in the oxidation step, and the presence of the second coating portion can provide a stronger electrically insulating effect, thereby improving the tan δ and phase angle θ.

The average atomic concentration of R in the second coating portion is preferably not more than 49.5 atm %, more preferably not more than 45 atm %, still more preferably not more than 40 atm %. The average atomic concentration of R in the second coating portion may be at least 0.01 atm %, preferably at least 0.1 atm %.

The second coating portion contains Fe. The form of Fe is not limited but is preferably an iron oxide, more preferably an iron oxide mainly including Fe₂O₃. Moreover, for example, it may be at least partially amorphous. The average atomic concentration of Fe in the second coating portion is preferably at least 1 atm %, more preferably at least 15 atm %. The average atomic concentration of Fe in the second coating portion is also preferably not more than 99 atm %, more preferably not more than 70 atm %, still more preferably not more than 60 atm %, particularly preferably not more than 40 atm %. The second coating portion containing Fe increases the chemical stability of the first coating portion of the coated rare earth-iron-nitrogen-based powder, enhancing the electrically insulating effect. The crystallinity and the diameter of the fine crystals can be determined by lattice image observation using a TEM method or by analysis using an ED device attached to a TEM device. Phosphorus compounds containing fine crystals of less than 1 nm can be considered as amorphous.

The thickness of the second coating portion is preferably at least 0.001% but not more than 100%, more preferably at least 0.01% but not more than 10% of the average particle size of the core region. The thickness of the second coating portion is also preferably at least 1 nm but not more than 100 nm, more preferably at least 2 nm but not more than 50 nm.

In the second coating portion, the average atomic concentration of 0 is preferably at least 0.5 times but not more than five times, more preferably at least one time but not more than four times the average atomic concentration of Fe. The atomic concentration (atm %) can be determined by averaging the atomic concentrations (atm %) in the second coating portion measured in a STEM-EDX line scan.

The region of the second coating portion preferably has small variations in the composition of each atom selected from O, Fe, Nd, P, and R. In this case, the crystallinity in the second coating portion tends to be improved, resulting in more homogeneous P, R, and Fe atomic compositions. For example, this may be confirmed by an EDX line scan across the second coating portion in which continuous measurements are performed in steps of 0.1 to 0.3 nm, as described for the first coating portion. The second coating portion including the above-described structure tends to provide improved stability.

Moreover, it is believed that when the first coating portion undergoes a transition from a eutectic or mixed crystal of a rare earth phosphate and an iron phosphate and/or a M phosphate to a single phase of the rare earth phosphate during the oxidation step after phosphorus treatment, the iron component may separate from the first coating portion, whereby the second coating portion or the second coating portion and the above-described Fe-rich region may be formed. A third coating portion containing a rare earth and/or P may also be present further outside the second coating portion.

The mechanism of the formation of the third coating portion is believed to be that the second coating portion may be formed along a crack or other flaw in the first coating portion during the oxidation step, or that a part of the first coating portion separated from the powder surface during the phosphorus treatment, or a phosphate generated in the liquid may be attached or bonded to the outside of the second coating portion. The inclusion of the third coating portion may increase the effect of electrical insulation between the particles of the coated rare earth-iron-nitrogen-based powder to further improve the tan δ and phase angle θ, and at the same time may reduce the μ Thus, this embodiment is suitable for applications requiring higher efficiency.

The average atomic concentration of R in the third coating portion is preferably at least 1 atm % but not more than 50 atm %, more preferably at least 5 atm % but not more than 50 atm %. The average atomic concentration of P in the third coating portion is preferably at least 1 atm % but not more than 50 atm %, more preferably at least 5 atm % but not more than 40 atm %. The average atomic concentration of Mo in the third coating portion is preferably at least 0 atm % but not more than 20 atm %, more preferably at least 0.01 atm % but not more than 10 atm %.

The thickness of the third coating portion is preferably at least 0% but not more than 100%, more preferably at least 0.0001% but not more than 20% of the average particle size of the core region. The thickness of the third coating portion is also preferably at least 0 nm but not more than 1000 nm, more preferably at least 0.1 nm but not more than 100 nm.

The average atomic concentration of Mo in the third coating portion is preferably at least 0.5 atm % but not more than 30 atm %, more preferably at least 1 atm % but not more than 20 atm %, still more preferably at least 1.2 atm % but not more than 15 atm %. When the average atomic concentration of Mo in the third coating portion is within the above range, the oxidation stability of the magnetic powder tends to be further improved. The average atomic concentration of Mo can be determined by averaging the atomic concentrations (atm %) in the third coating portion measured in a STEM-EDX line scan.

### Average Particle Size of Magnetic Powder

The average particle size of the coated rare earth-iron-nitrogen-based magnetic powder is preferably at least 0.1 μm but not more than 100 μm. For a magnetic material for magnetic field amplification, it is preferably at least 1 μm but not more than 100 μm. For a magnetic material for hyper-high frequency absorption, it is preferably at least 0.1 μm but not more than 10 μm. A more preferred particle size range is at least 3 μm but not more than 100 μm for a later-described magnetic material for magnetic field amplification, or is at least 0.1 μm but not more than 3 μm for a magnetic material for hyper-high frequency absorption. If the average particle size is less than 1 μm, the amount of the magnetic powder filled in the molded product may be reduced, so that the real part of the relative permeability in a high frequency range or the imaginary part of the relative permeability in a hyper-high frequency range may decrease. If the average particle size is not more than 0.1 μm, the volume fraction of a magnetic part having a high real part of the relative permeability in a high frequency range or a high imaginary part of the relative permeability in a hyper-high frequency range may decrease as the specific surface area is further increased. Consequently, the magnetic material properties tend to be drastically lowered. If the average particle size is more than 10 μm, the μ″ of the molded product tends to decrease. This tendency is more significant when the average particle size is more than 100 μm. Here, the average particle size refers to the median diameter measured under dry conditions using a laser diffraction particle size distribution analyzer. Specifically, the average particle size of the magnetic powder herein is defined as D50, which corresponds to the 50th percentile of the cumulative particle size distribution by volume of the coated rare earth-iron-nitrogen-based magnetic powder.

As the particle size of the rare earth-iron-nitrogen-based magnetic powder increases, eddy currents may start to occur in the particles at a low frequency due to the skin effect. Thus, the larger the particle size, the lower the frequency region where the tan δ and phase angle θ may start to deteriorate. Therefore, the magnetic powder having a small particle size tends to maintain high magnetic field amplification characteristics or hyper-high frequency absorption characteristics at up to high frequencies. In the case of Nd₂Fe₁₇N₃, for example, the relationship between the particle size r (μm) of the magnetic powder and the frequency f₀ (Hz) at which the real part of the relative permeability starts to decrease is presumably f₀=1 THz with r=0.1 μm, f₀=1 GHz with r=3 μm, and f₀=1 MHz with r=100 μm. Therefore, the rare earth-iron-nitrogen-based magnetic powder having a particle size with an upper limit around the above range is preferred as a magnetic field amplification material according to the present disclosure. Moreover, a smaller particle size cannot gain the filling ratio of the molded product and also increases the surface area. For example, when the magnetic powder includes a first coating portion having a thickness of 10 nm, the relative permeability can be reduced only by about 50% if the particle size of the powder is 0.1 μm, but the relative permeability can be about 6% if the particle size is 0.05 μm. Thus, the lower limit of the powder particle size of the magnetic powder according to the present disclosure can be around 0.1 μm, regardless of the frequency. In consideration of the above-described tradeoff, the particle size is preferably adjusted to a range more suitable for the target frequency range of the magnetic material.

### Phosphorus Concentration

The amount of phosphorus compounds in the coated rare earth-iron-nitrogen-based magnetic powder is preferably at least 0.5% by mass but not more than 4.5% by mass, more preferably at least 0.55% by mass but not more than 2.5% by mass, still more preferably at least 0.75% by mass but not more than 2% by mass. If the amount is more than 4.5% by mass, the rare earth-iron-nitrogen-based magnetic powder tends to aggregate, resulting in a lower relative permeability, and at the same time, the tan δ and phase angle θ in a high frequency range tend to deteriorate. If the amount is less than by mass, the electrically insulating effect of the first coating portion tends to decrease, similarly resulting in a lower relative permeability, and the tan δ in a high frequency range tends to deteriorate.

Moreover, the phosphorus content of the coated rare earth-iron-nitrogen-based magnetic powder is preferably at least 0.02% by mass, more preferably at least 0.05% by mass, still more preferably at least 0.15% by mass. The phosphorus content of the coated rare earth-iron-nitrogen-based magnetic powder is preferably not higher than 4% by mass, more preferably not higher than 2% by mass, still more preferably not higher than 1% by mass.

With regard to the phosphorus compounds, the first and second coating portions preferably cover at least a part of the surface of the powder formed from the core region in order not to cause an efficiency reduction due to eddy currents, i.e., an increase in tan δ and a deterioration of the phase angle θ, in a high frequency range. In the magnetic powder, a surface coverage of at least 10% can have the eddy current reducing effect to some degree. Desirably, the surface coverage is preferably at least 50%, more preferably at least 80%. A surface coverage of lower than 10% is not preferable because it cannot sufficiently inhibit inter-particle eddy currents, resulting in deteriorated tan δ and phase angle θ. The rare earth-iron-nitrogen-based magnetic powder with 100% coverage with the first coating portion can provide noticeably improved tan δ and phase angle θ and may achieve a tan δ of not more than 0.01 and a 0 of at least 89.4° at 1 MHz, depending on the composition, crystal structure, powder particle size, etc. of the magnetic powder.

A phosphorus compound preferably covers at least a part of the surface of the powder formed from the core region in order not to cause a reduction in relative permeability, particularly μ, due to eddy currents in a hyper-high frequency range, i.e., a deterioration of hyper-high frequency absorption characteristics. A surface coverage of at least 10% can have the eddy current reducing effect to some degree. Desirably, the surface coverage is preferably at least 50%, more preferably at least 80%. A surface coverage of lower than 10% is not preferable because it cannot sufficiently inhibit inter-particle eddy currents, so that the μ″ may be reduced by the skin effect. The rare earth-iron-nitrogen-based magnetic powder with 100% coverage with the phosphorus compound can show an extremely small reduction in relative permeability due to eddy currents and may achieve a μ″ of at least 1 at 1 GHz, depending on the composition, crystal structure, powder particle size, etc. of the magnetic powder.

### High-Frequency Characteristics

The coated rare earth-iron-nitrogen-based magnetic powder preferably has a ratio of θ₁/θ₂ of at least 0.8, more preferably at least 0.85, where θ₁ represents the phase angle at 100 MHz and θ₂ represents the phase angle at 13 MHz. When the ratio of θ₁/θ₂ is at least 0.8, a reduction in energy efficiency can be reduced even at high frequencies. Here, the phase angle θ is determined when the μ′ (real part of the complex relative permeability) and the μ″ (imaginary part of the complex relative permeability) are presented on the complex plane. The phase angle θ of the coated rare earth-iron-nitrogen-based magnetic powder can be measured as described in EXAMPLES.

The phase angle θ at 13 MHz of the coated rare earth-iron-nitrogen-based magnetic powder is preferably at least 80°, more preferably at least 85°. The phase angle θ at 13 MHz of the coated rare earth-iron-nitrogen-based magnetic powder may be not larger than 90°. The magnetic powder having a phase angle θ at 13 MHz of at least 80° can have an extremely high loss-reducing effect and is suitable for receiving and transmitting applications such as wireless power transfer and radio frequency identification (RFID). Moreover, the phase angle θ at 30 MHz of the coated rare earth-iron-nitrogen-based magnetic powder is preferably at least 60°, more preferably at least 70°. The phase angle θ at 30 MHz of the coated rare earth-iron-nitrogen-based magnetic powder may be not larger than 90°. The magnetic powder having a phase angle θ at 30 MHz of at least 60° can have an extremely high loss-reducing effect and is suitable for receiving and transmitting applications such as inductors.

Moreover, the rare earth-iron-nitrogen-based magnetic powder according to the present embodiments has planar magnetocrystalline anisotropy in which the magnetic moment tends to be directed to the c-plane direction rather than the c-axis direction. It is extremely important for the magnetic powder according to the present embodiments to have this feature in order to maintain a high real part μ′ of the relative permeability in a high frequency range and further to provide a high imaginary part μ″ of the relative permeability in a hyper-high frequency range. The magnetic powder according to the present embodiments has a very large absolute value of the negative magnetic crystalline anisotropy energy. Further, such magnetic powder having planar magnetocrystalline anisotropy is present without orientation, and the natural resonance frequency is widely distributed within a hyper-high frequency range of at least 1 GHz but not higher than 1 THz. Thus, an increase in μ″ and a decrease in μ′ due to natural resonance may not occur at lower than 1 GHz, while a high μ″ due to natural resonance may occur in a broad frequency band of at least 1 GHz but not higher than 1 THz. Particularly in the magnetic powder according to the present embodiments, the surface of the ferromagnetic powder is coated with the phosphorus compound in the magnetic powder, and the phosphorus compound is present between the particles of the magnetic powder, which can inhibit the generation of inter-particle eddy currents. Moreover, when the magnetic powder has a predetermined average particle size, the generation of intra-particle eddy currents can also be inhibited. Thus, the inherent high-frequency characteristics of the magnetic powder tend to further improve in a frequency range of 1 MHz to 1 THz as the deterioration due to eddy currents may be reduced. There is no known “magnetic field amplification material” created according to a material design concept that takes into account such a broad frequency band. There is also no know “hyper-high frequency absorbing material” which can function seamlessly in a “very broad frequency band” according to the same design concept.

### Magnetic Material for Magnetic Field Amplification

The magnetic material for magnetic field amplification according to the present embodiments includes the coated rare earth-iron-nitrogen-based magnetic powder. The magnetic material including the coated rare earth-iron-nitrogen-based magnetic powder has a high relative permeability with a μ′ of at least 2 in a frequency range of at least 1 MHz but lower than 1 GHz for magnetic field amplification and also includes a region with a tan δ of not more than 0.2 and a phase angle θ of at least 78.7° in a frequency range of at least 1 MHz but lower than 1 GHz, and may also have excellent efficiency as well.

The coated rare earth-iron-nitrogen-based magnetic powder preferably has a particle size of at least 1 μm but not more than 100 μm. The reason for this is that, as described above, if powder larger than 100 μm is used in a magnetic material for magnetic field amplification at a frequency of at least 1 MHz, the relative permeability tends to decrease due to the skin effect. Further, when powder of at least 7 μm is used in a magnetic material for magnetic field amplification, as a high pressure of at least 0.5 GPa is usually applied to increase the volume fraction, the particles of the powder may come into contact with each other to cause a large eddy current loss, thereby greatly reducing the real part of the relative permeability. Therefore, it is preferred that a fine and moderately soft substance, such as a phosphorus compound, which is not as hard as oxides of ferrite or transition metals and not as soft as resins should coat rare earth-iron-nitrogen-based magnetic powder or should be present between the particles thereof. This can reduce a deterioration of the inherent properties such as relative permeability of the magnetic powder.

The magnetic material for magnetic field amplification may be suitably used at a frequency of at least 1 MHz but lower than 1 GHz. At a frequency of at least 1 GHz, it is also usable as a magnetic material for hyper-high frequency absorption. Therefore, depending on the composition, particle size distribution, etc. of the rare earth-iron-nitrogen-based magnetic powder, the imaginary part of the relative permeability may start to increase in a frequency range of at least 0.5 GHz but lower than 1 GHz. The magnetic material for magnetic field amplification according to the present embodiments may be used in a frequency range of at least 1 MHz but lower than 0.5 GHz, preferably at least 1 MHz but lower than 0.1 GHz. Use of the magnetic material as a material for magnetic field amplification in the above frequency range is preferred in terms of the balance between cost and properties because the powder of at least 3 μm but not more than 100 μm is used without using a fine grinding machine such as a jet mill, and it is not necessary to perform magnetic field orientation or other process which can reduce the throughput.

Examples of more specific applications of the magnetic material for magnetic field amplification include wireless power transfer coils, magnetic field amplification materials for RFID tags, and transformers, inductors, and reactors of circuits for high frequencies higher than 20 MHz. For example, the magnetic material may be used as a magnetic material for magnetic field amplification as follows: the magnetic material may be prepared in the form of a thin sheet and attached to the back of an antenna or a receiver/transmitter to concentrate the magnetic flux in the sheet by its magnetic field amplification characteristics; alternatively, the magnetic powder may be inserted into the inside of a cylindrical coil or rectangular parallelepiped coil, or a conducting wire may be wound around a donut-shaped magnetic core or a magnetic core with a yoke to improve the real part of the relative permeability of the coil.

The magnetic material for magnetic field amplification according to the present embodiments characteristically has a high real part of the relative permeability even in a high frequency range. For example, the real part of the relative permeability at a frequency of at least 1 MHz but not higher than 20 MHz is preferably at least 3, more preferably at least 4. Moreover, the real part of the relative permeability at a frequency of higher than 20 MHz but lower than 1 GHz is preferably at least 2, more preferably at least 3. Moreover, for example, the magnetic material for magnetic field amplification according to the present embodiments may have a real part μ′ of the relative permeability at a frequency of 20 MHz of at least 3.2, preferably at least 3.5, more preferably at least 4, still more preferably at least 4.5. The magnetic material for magnetic field amplification according to the present embodiments may have a real part μ′ of the relative permeability at a frequency of 20 MHz of, for example, not more than 200 or not more than 100.

The tan δ (μ″/μ′) and phase angle θ at 20 MHz of the magnetic material for magnetic field amplification according to the present embodiments are preferably not more than 0.33 and at least 71.7°, more preferably not more than 0.29 and at least 73.8°, still more preferably not more than 0.25 and at least 80.0°, respectively. Moreover, the tan δ and phase angle θ at 20 MHz may be not more than 0.0001 and at least 89.994°, respectively. When the tan δ and phase angle θ at 20 MHz are within the above respective ranges, the magnetic material may advantageously serve as a magnetic field amplification material with excellent efficiency and low cost, particularly when it is used around this frequency (for example, at least 10 MHz but not higher than 30 MHz). When the tan δ (μ″/μ′) and phase angle θ are not more than 0.33 and at least 71.7°, respectively, the heat generated in an element or system into which the magnetic material is incorporated can be reduced to reduce the temperature of the components, etc. Thus, the stability tends to be improved. When the tan δ and phase angle θ are not more than 0.0001 and at least 89.994°, respectively, the cost required to increase the material homogeneity can be reduced. Here, the complex relative permeability, the tan δ, and the phase angle θ can be determined by measuring the impedance of a toroidal sample using an impedance analyzer, a (vector) network analyzer, or a BH analyzer, and then converting the results to the complex relative permeability, tan δ, and phase angle θ, or by using the S parameter method, depending on the frequency range (for example, a measurement using a network analyzer at a frequency of at least 500 MHz).

The magnetic material for magnetic field amplification according to the present embodiments also characteristically has a relative permeability with low frequency dependence. For example, in a wireless power transfer application, where the power is supplied at a frequency of 13.56 MHz, a magnetic material whose real part μ′ of the relative permeability changes only slightly in a frequency range including this frequency of at least 2 MHz but not higher than 20 MHz exhibits excellent efficiency and is thus preferred. Moreover, as many materials have a relative permeability that changes greatly even at 5 MHz or lower, the material having a stable real part of the relative permeability in a frequency range of at least 2 MHz but not higher than 20 MHz is also preferred for applications in this frequency range, etc. In these applications, materials whose μ′ changes greatly in the above frequency range also tend to have a correspondingly large deviation of μ″ from 0, resulting in deteriorated tan δ and phase angle θ. The ratio of the real part of the relative permeability at 20 MHz to the real part of the relative permeability at 2 MHz is preferably at least 0.8, more preferably at least 0.9. The ratio of the real part of the relative permeability at 20 MHz to the real part of the relative permeability at 2 MHz may also be not higher than 1.1. When the ratio of the real parts of the relative permeabilities is at least 0.8, a decrease in energy efficiency tends to be reduced, so that the heat generated in a device into which the magnetic material is incorporated can be reduced. Moreover, when the ratio of the real parts of the relative permeabilities is not higher than 1.1, the input to and output from the device tend to be easily controllable.

The magnetic material for magnetic field amplification according to the present embodiments may contain a resin. A composite material of the magnetic material and a resin is referred to as a bonded magnetic material. The resin in the bonded magnetic material may be either a thermosetting resin or a thermoplastic resin. Examples of the thermoplastic resin include polyphenylene sulfide (PPS), polyether ether ketone (PEEK), liquid crystal polymers (LCP), polyamide (PA), polypropylene (PP), polyethylene (PE), and thermoplastic elastomers. Examples of the thermosetting resin include epoxy resins, phenolic resins, urea resins, melamine resins, guanamine resins, unsaturated polyester resins, vinyl ester resins, diallyl phthalate resins, polyurethane resins, silicone resins, polyimide resins, alkyd resins, furan resins, dicyclopentadiene resins, acrylic resins, allyl carbonate resins, and thermosetting elastomers commonly called rubbers.

The amount of the resin in the bonded magnetic material is preferably at least 0.1% by mass but not more than 95% by mass. When the amount of the resin component is at least 0.1% by mass, impact resistance can be further improved. When the amount is not more than 95% by mass, a drastic reduction in relative permeability or magnetization can be reduced. Further, in applications of the bonded magnetic material according to the present embodiments which require high relative permeability as well as impact resistance, the amount is more preferably in the range of at least 0.5% by mass but not more than 50% by mass because of the reason described above. In an application as a high frequency circuit transformer with particularly excellent efficiency, the amount is most preferably in the range of at least 1% by mass but not more than 15% by mass. To provide a magnetic material for magnetic field amplification according to the present embodiments with a particularly high real part of the relative permeability or a hyper-high frequency absorbing material with particularly good absorption characteristics, the amount is also preferably not more than 15% by mass which may vary more or less depending on the application. A non-sinter-hardened molded product containing no resin, for example, a compact which is prepared using an auxiliary agent such as a volatile organic solvent, is very fragile and thus is extremely difficult to apply to, for example, a magnetic field amplification material such as a wireless power transfer coil or an inductor magnetic coil, to which a load is applied, or a hyper-high frequency absorbing material mounted on a 5G+ or 6G mobile device which is frequently carried and subjected to high impact. Moreover, a molded product containing many penetrating air spaces, such as a compact pressed at a pressure of not higher than 1.5 GPa, tends to be unsuitable for applications at high temperatures because when exposed to a temperature of at least 50° C. for a long time, it may be oxidized and degraded or become extremely fragile, resulting in deteriorated impact resistance. Thus, the amount of the resin in the molded product for these applications is preferably at least 0.1% by mass but not more than 95% by mass, more preferably at least 0.5% by mass but not more than 50% by mass, still more preferably at least 1% by mass but not more than 15% by mass.

The resin compound for the bonded magnetic material may be prepared, for example, by mixing and/or kneading coated rare earth-iron-nitrogen-based magnetic powder and a resin using a kneading machine at a temperature of at least 180° C. but not higher than 300° C. For example, the coated rare earth-iron-nitrogen-based magnetic powder and the resin may be mixed using a mixer and then kneaded and extruded using a twin-screw extruder into a strand which may then be cooled in the air and cut into a size of several millimeters using a pelletizer, whereby pellets of the resin compound for the bonded magnetic material according to the present embodiments can be obtained.

The resin compound may be molded using an appropriate molding machine, whereby the bonded magnetic material according to the present embodiments can be produced. Specifically, for example, the resin compound may be melted in the barrel of a molding machine and then injection molded in a mold to which a magnetic field is applied to align the easy axes of magnetization (orientation step), thereby obtaining a magnetic field orientation-molded bonded magnetic material. Moreover, a bonded magnetic material sheet for magnetic field amplification or a bonded magnetic material sheet for hyper-high frequency absorption may be prepared by calendering or hot pressing the pellets of the resin compound. The sheet may be rolled to a thickness of at least 20 μm but not more than 200 μm to produce a magnetic material for magnetic field amplification having a high real part of the relative permeability, which may be suitably used as, for example, a magnetic material molded sheet for magnetic field amplification for RFID tags and may be used as a magnetic material molded sheet for hyper-high frequency absorption for mobile devices.

### Magnetic Material for Hyper-High Frequency Absorption

The magnetic material for hyper-high frequency absorption according to the present embodiments includes the coated rare earth-iron-nitrogen-based magnetic powder. The magnetic material including the coated rare earth-iron-nitrogen-based magnetic powder preferably has a high imaginary part μ″ of the relative permeability that is at least 0.1 in a frequency range of at least 1 GHz but not higher than 0.11 THz or is at least 0.23 in a frequency range of at least 1 GHz but not higher than 0.04 THz.

The coated rare earth-iron-nitrogen-based magnetic powder preferably has an average particle size of at least 0.1 μm but not more than 10 μm. The reason for this is as described above. The relative permeability of powder of at least 3 μm tends to decrease in a hyper-high frequency range of at least 1 GHz due to the skin effect, and therefore the powder particle size should be at least 0.1 μm, if possible, and direct contact between the magnetic particles should be avoided as much as possible. For example, if rare earth-iron-nitrogen-based magnetic powder of 30 μm is ground to a size of not more than 5 μm to be used as a hyper-high frequency magnetic material, the particles of the magnetic powder may come into contact with each other to be electrically connected during molding, and the electrically connected aggregates may have an average size of 30 μm. In this case, the effect of the particle size on high-frequency characteristics can be equal to that obtained when the unground powder is used, thus losing the purpose of grinding. Particularly, in the preparation of a magnetic sheet, where a molding method in which heat and pressure are simultaneously applied, such as hot pressing or calendering, is often employed, preferably, an insulating film such as a phosphorus compound is firmly adhered to the magnetic particle surface so that the magnetic particles are electrically insulated from each other even if the magnetic particles aggregate in the molded product matrix. A high frequency magnetic material having a high density and a high relative permeability can be produced by coating the surface of magnetic powder, which easily aggregates, with a fine and moderately soft phosphorus compound which is not as hard as oxides of ferrite or transition metals and applying heat and pressure simultaneously.

The magnetic material for hyper-high frequency absorption according to the present embodiments characteristically has a high imaginary part μ″ of the relative permeability even at hyper-high frequencies. For example, the imaginary part μ″ of the relative permeability at a frequency of at least 1 GHz but lower than 20 GHz is preferably at least 0.5, more preferably at least 0.8. Moreover, the imaginary part μ″ of the relative permeability at a frequency of at least 20 GHz but not higher than 1 THz is preferably at least 0.1, more preferably at least 0.2. Moreover, for example, the magnetic material for hyper-high frequency absorption according to the present embodiments may have an imaginary part μ″ of the relative permeability at a frequency of 10 GHz that is at least 0.4, preferably at least 0.5, more preferably at least 0.7, still more preferably at least 0.85. Moreover, for example, the magnetic material for hyper-high frequency absorption according to the present embodiments may have an imaginary part μ″ of the relative permeability at a frequency of 0.04 THz that is at least preferably at least 0.05, more preferably at least 0.1, still more preferably at least 0.23.

The magnetic material for hyper-high frequency absorption according to the present embodiments which contains the coated rare earth-iron-nitrogen-based magnetic powder can absorb hyper-high frequencies in a very broad frequency range of 1 GHz to 1 THz, and is distinct from magnetic materials which have a low relative permeability in a narrow frequency bandwidth of about 10 GHz, such as uniaxial magnetocrystalline anisotropic materials (e.g., hexagonal ferrite, boride, and epsilon iron oxide) which are expected to be used at such hyper-high frequencies. The presence of a phosphorus compound with high electrical resistivity in the magnetic powder is a key feature for planar magnetocrystalline anisotropic materials which have a lower electrical resistivity than oxide materials but have a higher resistance than metal materials and maintain the high-frequency characteristics at up to 1 THz.

Examples of more specific applications of the magnetic material for hyper-high frequency absorption include mobile communication equipment, mobile phone small base stations, and cloud base stations for 5th generation mobile communication systems (5G), 5th generation plus mobile communication systems (5G+), and 6th generation mobile communication systems (6G); components for absorbing hyper-high frequency signals and spurious signals for their infrastructure equipment such as apparatuses, devices, and antennas; components for absorbing hyper-high frequency signals and spurious signals for apparatuses or devices used in intelligent transport systems (ITS), wireless high-definition multimedia interface (HDMI) (registered trademark), wireless local area network (LAN), satellite broadcasting (Ka-band), etc.; and electromagnetic noise absorbing components for removing mainly the second to seventh harmonics in personal computers.

The magnetic material for hyper-high frequency absorption according to the present embodiments may contain a resin. A composite material of the magnetic material and a resin is referred to as a bonded magnetic material. The resin in the bonded magnetic material may be either a thermosetting resin or a thermoplastic resin. Examples of the thermoplastic resin include polyphenylene sulfide (PPS), polyether ether ketone (PEEK), liquid crystal polymers (LCP), polyamide (PA), polypropylene (PP), polyethylene (PE), and thermoplastic elastomers. Examples of the thermosetting resin include epoxy resins, phenolic resins, urea resins, melamine resins, guanamine resins, unsaturated polyester resins, vinyl ester resins, diallyl phthalate resins, polyurethane resins, silicone resins, polyimide resins, alkyd resins, furan resins, dicyclopentadiene resins, acrylic resins, allyl carbonate resins, and thermosetting elastomers commonly called rubbers.

The amount of the resin in the bonded magnetic material is preferably at least by mass but not more than 95% by mass. When the amount of the resin component is at least 0.1% by mass, impact resistance can be further improved. When the amount is not more than 95% by mass, a drastic reduction in relative permeability or magnetization can be reduced. Further, in applications of the bonded magnetic material according to the present embodiments which require high relative permeability as well as impact resistance, the amount is more preferably in the range of at least 0.5% by mass but not more than 50% by mass because of the reason described above. In an application as a high frequency circuit transformer with particularly excellent efficiency, the amount is still more preferably in the range of at least 1% by mass but not more than 15% by mass. To provide a magnetic material for magnetic field amplification according to the present embodiments with particularly high tan δ and phase angle θ or a hyper-high frequency absorbing material with particularly good absorption characteristics, the amount is also preferably not more than 15% by mass which may vary more or less depending on the application. A non-sinter-hardened molded product containing no resin, for example, a compact which is prepared using an auxiliary agent such as a volatile organic solvent, is very fragile and thus is extremely difficult to apply to, for example, a magnetic field amplification material such as a wireless power transfer coil or an inductor magnetic coil, to which a load is applied, or a hyper-high frequency absorbing material mounted on a 5G+ or 6G mobile device which is frequently carried and subjected to high impact. Moreover, a molded product containing many penetrating air spaces, such as a compact pressed at a pressure of not higher than 1.5 GPa, tends to be unsuitable for applications at high temperatures because when exposed to a temperature of at least 50° C. for a long time, it may be oxidized and degraded or become extremely fragile, resulting in deteriorated impact resistance. Thus, the amount of the resin in the molded product for these applications is preferably at least 0.1% by mass but not more than 95% by mass, more preferably at least 0.5% by mass but not more than 50% by mass, still more preferably at least 1% by mass but not more than 15% by mass.

The resin compound for the bonded magnetic material may be prepared, for example, by mixing and/or kneading a combination of a phosphorus compound, rare earth-iron-nitrogen-based magnetic powder, and a resin, or a combination of coated rare earth-iron-nitrogen-based magnetic powder and a resin using a kneading machine at a temperature of at least 180° C. but not higher than 300° C. For example, the coated rare earth-iron-nitrogen-based magnetic powder and the resin may be mixed using a mixer and then kneaded and extruded using a twin-screw extruder into a strand which may then be cooled in the air and cut into a size of several millimeters using a pelletizer, whereby pellets of the resin compound for the bonded magnetic material according to the present embodiments can be obtained.

The resin compound may be molded using an appropriate molding machine, whereby the bonded magnetic material according to the present embodiments can be produced. Specifically, for example, the resin compound may be melted in the barrel of a molding machine and then injection molded in a mold to which a magnetic field is applied to align the easy axes of magnetization (orientation step), thereby obtaining a magnetic field orientation-molded bonded magnetic material. Moreover, a bonded magnetic material sheet for magnetic field amplification or a bonded magnetic material sheet for hyper-high frequency absorption may be prepared by calendering or hot pressing the pellets of the resin compound. The sheet may be rolled to a thickness of at least 20 μm but not more than 200 μm to produce a magnetic material for magnetic field amplification having a high real part of the relative permeability, which may be suitably used as, for example, a magnetic material molded sheet for magnetic field amplification for RFID tags and may be used as a magnetic material molded sheet for hyper-high frequency absorption for mobile devices.

### Method of Producing Coated Rare Earth-Iron-Nitrogen-Based Magnetic Powder

A method of producing magnetic powder according to the present embodiments includes a phosphorus treatment including adding an inorganic acid to a slurry containing: rare earth-iron-nitrogen-based magnetic powder containing at least one rare earth R, Fe, and N, where R represents at least one selected from the group consisting of Y, Ce, Pr, Nd, Gd, Tb, Dy, Ho, Er, Tm, Lu, and Sm, and if Sm is present, Sm constitutes less than 50 atm % of the total R content; water; and a phosphorus-containing substance to form a phosphorus compound coating portion on the rare earth-iron-nitrogen-based magnetic powder, and an oxidation including heat-treating the rare earth-iron-nitrogen-based magnetic powder having the phosphorus compound coating portion at a temperature of at least 180° C. but not higher than 350° C. in an oxygen-containing atmosphere.

The rare earth-iron-nitrogen-based magnetic powder used in the production method according to the present embodiments contains R, Fe, and N, where R represents at least one selected from the group consisting of Y, Ce, Pr, Nd, Gd, Tb, Dy, Ho, Er, Tm, Lu, and Sm, and if Sm is present, Sm constitutes less than 50 atm % of the total R content. R is at least one selected from Y, Ce, Pr, Nd, Gd, Tb, Dy, Ho, Er, Tm, Lu, and Sm, preferably from Nd, Y, Ce, Pr, Gd, and Dy in view of stability of raw material supply and high relative permeability, more preferably from Nd, Y, Ce, and Pr in view of cost. Here, the amount of Sm, if present, is less than 50 atm %, preferably less than 20 atm % of the total R content. In particular, when the amount of Nd or Pr is at least 50 atm % of the total R content, a magnetic material with a higher relative permeability or a lower tan δ can be obtained. Further, in view of the balance between oxidation resistance and cost, the amount of Nd or Pr is preferably at least 70 atm %. The rare earth-iron-nitrogen-based magnetic powder particularly preferably includes NdFeN in which the amount of Nd is 100 atm % because of the high abundance of resources, the large absolute value of magnetocrystalline anisotropy field (index showing the level of magnetic anisotropy), and the high absorption ability at further hyper-high frequencies.

The amount of Fe in the rare earth-iron-nitrogen-based magnetic powder is preferably at least 40 atm % but not more than 87 atm %, more preferably at least 50 atm % but not more than 85 atm %.

### Phosphorus Treatment Step

The phosphorus treatment step includes adding an inorganic acid to a slurry that contains rare earth-iron-nitrogen-based magnetic powder containing R, Fe, and N, water, and a phosphorus-containing substance to form a phosphorus compound coating portion on the rare earth-iron-nitrogen-based magnetic powder. The phosphorus compound coating portion may be formed by reacting the metal component (for example, iron, neodymium, etc.) in the rare earth-iron-nitrogen-based magnetic powder with the phosphorus component (for example, phosphoric acid) in the phosphorus-containing substance to precipitate a phosphorus compound (for example, iron phosphate, neodymium phosphate, etc.). Moreover, the phosphorus compound coating portion is preferably formed by precipitating the phosphorus compound on the surface of the rare earth-iron-nitrogen-based magnetic powder so that it coats at least a part of the surface of the rare earth-iron-nitrogen-based magnetic powder (such coating is referred to as “phosphorus compound coating”, and the portion formed by such coating is referred to as “phosphorus compound coating portion”). Here, when an inorganic acid is added to adjust the pH of the slurry in the present embodiments, the amount of the precipitated phosphorus compound can be increased as compared to when no inorganic acid is added. Thus, phosphorus compound-coated rare earth-iron-nitrogen-based magnetic powder can be produced in which the thickness of the coating portion (also referred to as film thickness) is large and the tan δ is reduced, resulting in improved magnetic field amplification characteristics. Moreover, the use of water as a solvent according to the present embodiments allows the precipitated phosphorus compound such as phosphate to have a smaller particle size than that when using an organic solvent. Thus, the resulting rare earth-iron-nitrogen-based magnetic powder has a dense phosphorus compound coating portion and tends to provide excellent efficiency in a high frequency range or excellent absorption characteristics in a hyper-high frequency range.

The slurry that contains rare earth-iron-nitrogen-based magnetic powder containing R, Fe, and N, water, and a phosphorus-containing substance may be prepared by any method, such as mixing rare earth-iron-nitrogen-based magnetic powder with a phosphorus-containing substance solution containing a phosphorus-containing substance and water as a solvent. The amount of the rare earth-iron-nitrogen-based magnetic powder in the slurry is preferably at least 1% by mass but not more than 50% by mass. In view of productivity, the amount is preferably at least 5% by mass but not more than 20% by mass. The amount of the phosphorus-containing substance in the slurry is not limited. When the phosphorus-containing substance is a phosphoric acid and consists only of hydrogen and the phosphate component (PO₄), the amount of the phosphorus-containing substance, calculated as PO₄, is, for example, at least 0.01% by mass but not more than 10% by mass. In view of reactivity between the metal component and the phosphorus component and productivity, the amount is preferably at least 0.05% by mass but not more than 5% by mass.

Examples of the phosphorus-containing substance include phosphorus alone and compositions thereof; phosphate compounds such as orthophosphoric acid; heteropoly acid compounds such as phosphotungstic acid and phosphomolybdic acid; salts of phosphorus-containing acid compounds such as phosphate compounds or heteropoly acid compounds and metal ions or ammonium ions; organic phosphorus compounds such as phosphate esters, phosphite esters, and phosphine oxides; and phosphorus-containing metals such as iron phosphide, phosphor bronze, Fe—B—P—Cu alloys, and Fe—Nb—B—P alloys.

When the phosphorus-containing substance is a phosphate compound, an aqueous phosphate solution may be prepared by mixing the phosphate compound with water. Examples of the phosphate compound include orthophosphoric acid, sodium dihydrogen phosphate, sodium monohydrogen phosphate, ammonium dihydrogen phosphate, ammonium monohydrogen phosphate, zinc phosphate, calcium phosphate, and other phosphates, hypophosphorous acid and hypophosphites, pyrophosphoric acid, polyphosphoric acid, and other inorganic phosphoric acids, and organic phosphoric acids, and salts thereof. These may be used alone or in combinations of two or more. To improve the water resistance and corrosion resistance of the coating portion and the high-frequency characteristics of the magnetic powder, additives may also be used including, for example, oxoacid salts such as molybdates, tungstates, vanadates, and chromates; oxidizing agents such as sodium nitrate and sodium nitrite; and chelating agents such as EDTA. In view of reaction control and coating amount control, phosphate compounds such as inorganic phosphoric acids such as orthophosphoric acid, pyrophosphoric acid, and polyphosphoric acid, and phosphates of these inorganic phosphoric acids with Na, Ca, Pb, Zn, Fe, Y, Ce, Pr, Nd, Gd, Tb, Dy, Ho, Er, Tm, Lu, Sm, ammonium, etc. are preferred among the phosphorus-containing substances.

The phosphate concentration (calculated as PO₄) in the aqueous phosphate solution is preferably at least 5% by mass but not more than 50% by mass, but in view of the solubility and storage stability of the phosphate compound and ease of chemical treatment, it is more preferably at least 10% by mass but not more than 30% by mass. The pH of the aqueous phosphate solution is preferably at least 1 but not higher than 4.5, but it is preferably at least 1.5 but not higher than 4 in order to easily control the precipitation rate of the phosphate. The pH may be adjusted using dilute hydrochloric acid, dilute sulfuric acid, or the like.

In the phosphorus treatment step, an inorganic acid is added to make the slurry acidic. The pH is preferably adjusted to be at least 1 but not higher than 4.5, more preferably at least 1.6 but not higher than 3.9, still more preferably at least 2 but not higher than 3. If the pH is lower than 1, aggregation of the rare earth-iron-nitrogen-based magnetic powder particles tends to occur starting from the locally highly precipitated phosphorus compound, resulting in deteriorated tan δ in a high frequency range and lower μ″ in a hyper-high frequency range. If the pH is higher than 4.5, the amount of the precipitated phosphorus compound such as phosphate tends to decrease, resulting in deteriorated tan δ in a high frequency range and lower μ″ in a hyper-high frequency range. Examples of the inorganic acid to be added include hydrochloric acid, nitric acid, sulfuric acid, boric acid, and hydrofluoric acid. In the phosphorus treatment step, the inorganic acid is preferably added as needed to adjust the pH within the above-described range. Although the inorganic acid is used in view of liquid waste disposal, an organic acid may be used together depending on the purpose. Examples of the organic acid include acetic acid, formic acid, and tartaric acid.

The phosphorus treatment step may be performed such that the resulting magnetic powder has a phosphorus content of at least 0.02% by mass. The phosphorus content of the magnetic powder obtained in the phosphorus treatment step is preferably at least 0.05% by mass, more preferably at least 0.15% by mass. The phosphorus content of the magnetic powder obtained in the phosphorus treatment step is preferably not higher than 4% by mass, more preferably not higher than 2% by mass, still more preferably not higher than 1% by mass. A phosphorus content of at least 0.02% by mass tends to further increase the effect of the phosphorus compound coating. A phosphorus content of not higher than 4% by mass tends to reduce an increase in tan δ in a high frequency range and a decrease in μ″ in a hyper-high frequency range due to aggregation of the rare earth-iron-nitrogen-based magnetic powder starting from the phosphorus compound. Particularly, to prepare a magnetic material for magnetic field amplification having excellent efficiency or a magnetic material for hyper-high frequency absorption having excellent absorption characteristics, the phosphorus content is preferably at least 0.15% by mass but not higher than 1% by mass. Here, the bulk phosphorus content of the total magnetic powder can be measured by ICP atomic emission spectroscopy (ICP-AES). Moreover, the local phosphorus contents of the magnetic powder phase and phosphorus compound coating portion in the phosphorus compound-coated powder can be measured by energy-dispersive X-ray spectroscopy (STEM-EDX). Moreover, the atomic concentration of phosphorus (P) in the phosphorus compound coating portion is preferably at least 1 atm %, more preferably at least 5 atm %. The atomic concentration of P in the phosphorus compound coating portion may also be not more than 25 atm %, preferably not more than 15 atm %. If the phosphorus content of the phosphorus compound coating portion is less than 1 atm %, the phosphorus compound tends not to easily serve as an electrical insulation. If the phosphorus content is more than 25 atm %, not only do the real part of the relative permeability in a high frequency range and the imaginary part of the relative permeability in a hyper-high frequency range tend to decrease, but also the corrosion resistance performance tends to decrease.

The adjustment of the pH of the slurry containing rare earth-iron-nitrogen-based magnetic powder, water, and a phosphorus-containing substance within the range of at least 1 but not higher than 4.5 is preferably performed for at least 10 minutes. To reduce the thin parts of the coating portion, the adjustment is more preferably performed for at least 30 minutes. In the pH maintenance, as the pH initially increases rapidly, the inorganic acid for pH control needs to be introduced at short intervals. Then, as the coating proceeds, the pH change gradually decreases, and therefore the inorganic acid may be introduced at longer intervals, which allows one to determine the end point of the reaction.

Oxidation Step after Phosphorus Treatment

The rare earth-iron-nitrogen-based magnetic powder having a phosphorus compound coating portion obtained in the phosphorus treatment step may be heat-treated at a temperature of at least 180° C. but not higher than 350° C. in an oxygen-containing atmosphere for oxidation. The oxidation step after phosphorus treatment may be performed so that the average atomic concentration of the rare earth R in a first coating portion is higher than the average atomic concentration of R in the base material rare earth (R)-iron-nitrogen-based magnetic powder, and the average atomic concentration of R in the first coating portion is not more than twice the average atomic concentration of R in the base material rare earth-iron-nitrogen-based magnetic powder. Although the oxidation step may be performed so that the average atomic concentration of R in a first coating portion is higher than the average atomic concentration of R in the rare earth-iron-nitrogen-based magnetic powder, the average atomic concentration of R in the first coating portion is preferably adjusted to be at least 1.05 times, more preferably at least 1.1 times, still more preferably at least 1.2 times, particularly preferably at least 1.5 times the average atomic concentration of R in the base material rare earth-iron-nitrogen-based magnetic powder. Moreover, the oxidation step may be performed so that the average atomic concentration of R in the first coating portion is not more than twice, preferably not more than 1.9 times, more preferably not more than 1.8 times the average atomic concentration of R in the rare earth-iron-nitrogen-based magnetic powder. Here, the first coating portion is a region including a layer that shows a phosphorus (P) peak in a STEM-EDX line scan of the magnetic powder. For example, the thickness of the first coating portion is preferably at least 1 nm but not more than 200 nm, more preferably at least 2 nm but not more than 100 nm, still more preferably at least 5 nm but not more than 80 nm, particularly preferably at least 10 nm but not more than 60 nm. The average atomic concentration (atm %) of each element in the first coating portion can be determined by averaging the atomic concentrations in the first coating portion measured in a STEM-EDX line scan. The rare earth element R may be Nd, for example.

The oxidation treatment may allow the surface of the rare earth-iron-nitrogen-based magnetic powder to be oxidized to form an iron oxide layer, which improves the oxidation resistance of the magnetic powder. Moreover, as the oxidation after the phosphorus treatment may promote the crystallization of the amorphous portion, and the heating may improve the crystallinity of the coating portion, the variations in the composition of each element in the first coating portion tend to be reduced. Therefore, the homogeneity of the P and Nd compositions in the first coating portion or second coating portion may be further increased. This is because, for example, when measured in an EDX line scan across the first and second coating portions in which continuous measurements are performed in steps of 0.1 to 0.3 nm, the compositional variations in the phosphorus compound coating portion after the “oxidation step after phosphorus treatment” may be small even though the compositional variations before the “oxidation step after phosphorus treatment” are large. Here, it can be determined as described earlier for the first coating portion whether the compositional variations are small. Moreover, the oxidation can inhibit undesirable oxidation-reduction reaction, decomposition reaction, and alteration from occurring on the particle surface of the rare earth-iron-nitrogen-based magnetic powder when the magnetic powder is exposed to high temperatures. This may result in a magnetic material having magnetic field amplification characteristics with a low tan δ in a high frequency range and absorption characteristics with a high μ″ in a hyper-high frequency range.

The oxidation may be carried out by heat-treating the phosphorus-treated magnetic powder in an oxygen-containing atmosphere. The reaction atmosphere preferably contains oxygen in an inert gas such as nitrogen or argon. The oxygen concentration is preferably at least 3% but not more than 21%, more preferably at least 3.5% but not more than 10%. During the oxidation reaction, gas exchange is preferably performed at a flow rate of at least 2 L/min but not higher than 10 L/min per 1 kg of the magnetic powder.

The temperature during the oxidation is at least 180° C. but not higher than 350° C., preferably at least 200° C. but not higher than 330° C., more preferably at least 220° C. but not higher than 310° C., still more preferably at least 250° C. but not higher than 280° C. If the temperature is lower than 180° C., long-term oxidation tends to be required, resulting in reduced productivity. If the temperature is higher than 350° C., the coated rare earth-iron-nitrogen-based magnetic material tends to decompose. The reaction time is preferably at least three hours but not more than 10 hours.

### Silica Treatment Step

The magnetic powder obtained through the phosphorus treatment step and the oxidation step may optionally be subjected to a silica treatment. The formation of a silica thin film on the magnetic powder enhances oxidation resistance. The silica thin film may be formed, for example, by mixing an alkyl silicate, the magnetic powder, and an alkali solution.

### Silane Coupling Treatment Step

The silica-treated magnetic powder may be further treated with a silane coupling agent. When the magnetic powder provided with a silica thin film is subjected to a silane coupling treatment, a coupling agent film may be formed on the silica thin film, which improves the magnetic properties of the magnetic powder as well as wettability between the magnetic powder and the resin and the strength of the molded product. Any silane coupling agent may be used and may be selected depending on the resin type. Examples of the silane coupling agent include 3-aminopropyltriethoxysilane, γ-(2-aminoethyl)aminopropyltrimethoxysilane, γ-(2-aminoethyl)aminopropylmethyldimethoxysilane, γ-methacryloxypropyltrimethoxysilane, γ-methacryloxypropylmethyldimethoxysilane, N-β-(N-vinylbenzylaminoethyl)-γ-aminopropyltrimethoxysilane hydrochloride, γ-glycidoxypropyltrimethoxysilane, γ-mercaptopropyltrimethoxysilane, methyltrimethoxysilane, methyltriethoxysilane, vinyltriacetoxysilane, γ-chloropropyltrimethoxysilane, hexamethylenedisilazane, γ-anilinopropyltrimethoxysilane, vinyltrimethoxysilane, octadecyl[3-(trimethoxysilyl)propyl]ammonium chloride, γ-chloropropylmethyldimethoxysilane, γ-mercaptopropylmethyldimethoxysilane, methyltrichlorosilane, dimethyldichlorosilane, trimethylchlorosilane, vinyltrichlorosilane, vinyltris(β-methoxyethoxy)silane, vinyltriethoxysilane, β-(3,4-epoxycyclohexyl)ethyltrimethoxysilane, γ-glycidoxypropylmethyldiethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, ureidopropyltriethoxysilane, γ-isocyanatopropyltriethoxysilane, polyethoxydimethylsiloxane, polyethoxymethylsiloxane, bis(trimethoxysilylpropyl)amine, bis(3-triethoxysilylpropyl)tetrasulfane, γ-isocyanatopropyltrimethoxysilane, vinylmethyldimethoxysilane, 1,3,5-N-tris(3-trimethoxysilylpropyl)isocyanurate, t-butyl carbamate trialkoxysilane, and N-(1,3-dimethylbutylidene)-3-(triethoxysilyl)-1-propaneamine. These silane coupling agents may be used alone or in combinations of two or more. The amount of the silane coupling agent added per 100 parts by mass of the magnetic powder is preferably at least 0.2 parts by mass but not more than 0.8 parts by mass, more preferably at least 0.25 parts by mass but not more than 0.6 parts by mass. If the amount is less than 0.2 parts by mass, the effect of the silane coupling agent tends to be small. If the amount is more than 0.8 parts by mass, the magnetic properties of the magnetic powder or molded product tend to decrease due to aggregation of the magnetic powder.

Moreover, the silica treatment step and/or silane coupling treatment step may be replaced or followed by subjecting the magnetic powder to a surface treatment with a coupling agent, examples of which include titanium coupling agents such as isopropyl triisostearoyl titanate, isopropyl tri(N-aminoethyl-aminoethyl)titanate, isopropyl tris(dioctylpyrophosphate)titanate, tetraisopropyl bis(dioctylphosphite)titanate, tetraisopropyl titanate, tetrabutyl titanate, tetraoctyl bis(ditridecylphosphite)titanate, isopropyl trioctanoyl titanate, isopropyl tridodecylbenzenesulfonyl titanate, isopropyl tri(dioctylphosphate)titanate, bis(dioctylpyrophosphate)ethylenetitanate, isopropyl dimethacryl isostearoyl titanate, tetra(2,2-diallyloxymethyl-1-butyl)bis(ditridecylphosphite)titanate, and isopropyl tricumyl phenyl titanate, aluminum coupling agents such as acetoalkoxyaluminum diisopropylate; zirconium coupling agents, chromium coupling agents, iron coupling agents, and tin coupling agents. When the powder obtained through this treatment is used as a bonded magnetic material, the affinity with the resin added may be improved, the isolation and dispersion of the coated rare earth-iron-nitrogen-based magnetic powder may become more significant, and electrical insulation between the powder particles may be provided, resulting in excellent efficiency in a high frequency range or excellent absorption characteristics in a hyper-high frequency range.

The magnetic powder obtained after the phosphorus treatment step, oxidation step, silica treatment step, or silane coupling treatment step may be filtered, dehydrated, and dried in a usual manner.

### EXAMPLES

Embodiments of the present disclosure are more specifically described with reference to the examples and the like below, which, however, are not intended to limit the scope of the present disclosure.

The evaluations performed in the examples are described below.

### Atomic Concentration

The thicknesses and atomic concentrations of the core region and coating portions of the coated rare earth-iron-nitrogen-based magnetic powder were measured as follows. First, the obtained magnetic powder was dispersed and carbon-coated on a carbon-coated carbon tape and then cross-sectioned using a focused ion beam (FIB) to obtain a cross-section sample for measurement. The thicknesses and atomic concentrations of the sample were estimated using STEM (JEOL, model No. JEM-F200, acceleration voltage: 200 kV) and STEM-EDX (system: model No. SD100HR, JEOL, detector: dry SD detector, JEOL) attached to the STEM. To determine the atomic concentrations in the phosphorus compound coating portion, a line scan was performed in steps of 0.159 nm or 0.239 nm from the exterior to the interior of the phosphorus compound-coated magnetic powder to observe continuous changes in the atomic concentrations of the structural elements, thereby determining a region where the atomic concentration of phosphorus (P) was at least 1 atm %. Here, since a lot of the carbon (C) in the resin used to prepare the cross-section sample might be detected in some measurement points, the atomic concentrations were calculated based on the sum of those of the elements excluding C. Moreover, the average atomic concentrations in the regions were each calculated by dividing the sum of the atomic concentrations at each point determined as above by the number of points obtained in the measurement.

### Measurement of Complex Relative Permeability and Phase Angle θ at 13 to 100 MHz

The magnetic powder was mixed with an epoxy resin (thermosetting resin) and then kneaded to prepare a resin compound. The resin compound was charged into a mold having an inner diameter of 3.1 mm and an outer diameter of 8 mm, molded at an increased pressure of 0.8 GPa, and then heat-cured in vacuum at 150° C. for two hours to prepare a toroidal molded product. Using an impedance analyzer (HP4291B, Hewlett-Packard Company), the complex relative permeability of this sample in a frequency range of 13 MHz to 100 MHz was evaluated from the inductance determined using a single-turn inductor-type test fixture.

### Measurement of Complex Relative Permeability at 10 GHz to 0.04 THz

The magnetic powder was mixed with an epoxy resin (thermosetting resin) and then kneaded to prepare a resin compound. The resin compound was charged into 1) a toroidal mold having an inner diameter of 3.04 mm and an outer diameter of 7 mm, 2) a 10.67 mm×4.32 mm rectangular mold, or 3) a 7.11 mm×3.56 mm rectangular mold and molded at an increased pressure of 0.8 GPa to give a thickness of about 1 mm. Using a network analyzer (N5290A, Keysight Technologies), the complex relative permeability of the sample 1) in a frequency range of 1 to 18 GHz was evaluated from the S-parameter determined by a coaxial method. Moreover, using the network analyzer, the complex relative permeabilities of the samples 2) and 3) in a frequency range of 18 to 26.5 GHz and 26.5 to 40 GHz (=0.04 THz), respectively, were evaluated from the S-parameters determined by a waveguide method.

### Comparative Example 1

Non-phosphorus-treated Nd₂Fe₁₇N₃ magnetic powder having an average particle size of about 10 μm was prepared from iron sulfate and neodymium sulfate as raw materials by a precipitation method as described below.

### Preparation of Nd—Fe Sulfuric Acid Solution

FeSO₄·7H₂O in an amount of 5.0 kg was mixed and dissolved in 2.0 kg of pure water. Then, 0.45 kg of Nd₂O₃ and 0.70 kg of 70% sulfuric acid were added and stirred well until they were completely dissolved. Next, pure water was added to the resulting solution so that the final Fe and Nd concentrations were adjusted to 0.726 mol/L and 0.106 mol/L, respectively, to give a Nd—Fe sulfuric acid solution.

### Precipitation Step

The entire amount of the prepared Nd—Fe sulfuric acid solution was added dropwise with stirring to 20 kg of pure water kept at a temperature of 40° C. over 70 minutes from the start of the reaction, while 15% ammonia water was added dropwise to adjust the pH to 7 to 8. Thus, a slurry containing a Nd—Fe hydroxide was obtained. The slurry was washed with pure water by decantation, followed by solid-liquid separation of the hydroxide. The separated hydroxide was dried in an oven at 100° C. for 10 hours.

### Oxidation Step

The hydroxide obtained in the precipitation step was fired in the atmosphere at 1030° C. for one hour and then cooled to obtain a red Nd—Fe oxide as raw material powder.

### Pretreatment Step

An amount of 100 g of the Nd—Fe oxide was put in a steel vessel to a thickness of 10 mm. The vessel was placed in a furnace, and the pressure was reduced to 100 Pa. Then, while introducing hydrogen gas, the temperature was increased to a pretreatment temperature of 850° C. and maintained at this temperature for 15 hours to obtain a partial oxide as black powder.

### Reduction Step

An amount of 60 g of the partial oxide obtained in the pretreatment step was mixed with 19.2 g of metallic calcium having an average particle size of about 6 mm, and the mixture was placed in a furnace. After vacuum evacuation of the furnace, argon gas (Ar gas) was introduced. The temperature was increased to 1045° C. and maintained for 45 minutes to obtain Fe—Nd alloy particles.

### Nitridation Step

Subsequently, the temperature inside the furnace was lowered to 100° C., followed by vacuum evacuation. Then, while introducing nitrogen gas, the temperature was increased to 450° C. and maintained at this temperature for 23 hours to obtain a magnetic particle-containing bulk product.

### Water Washing Step

The bulk product obtained in the nitridation step was introduced into 3 kg of pure water and stirred for 30 minutes. After standing still, the supernatant was drained by decantation. The introduction into pure water, stirring, and decantation were repeated 10 times. Then, 2.5 g of 99.9% acetic acid was introduced and stirred for 15 minutes. After standing still, the supernatant was drained by decantation. The introduction into pure water, stirring, and decantation were repeated twice, followed by dehydration, drying, and then mechanical crushing to obtain Nd₂Fe₁₇N₃ magnetic powder having an average particle size of about 10 μm.

### Reference Example 1

The Nd₂Fe₁₇N₃ magnetic powder prepared in Comparative Example 1 was subjected to phosphorus treatment as follows. A phosphate treatment liquid was prepared by mixing 85% orthophosphoric acid, sodium dihydrogen phosphate, and sodium molybdate dihydrate at a mass ratio of 1:6:1, respectively, and adding pure water and dilute hydrochloric acid to adjust the pH and the PO₄ concentration to 2 and 20% by mass, respectively. The Nd—Fe—N-based magnetic powder obtained in the water washing step was stirred in a dilute hydrochloric acid containing 1000 g of water and 70 g of hydrogen chloride for one minute to remove the oxidized surface film and contaminants, followed by repeating draining and supplying water until the supernatant had a conductivity of not higher than 100 μS/cm. Thus, a slurry containing 10% by mass of the Nd—Fe—N-based anisotropic magnetic powder was obtained. Then, while stirring the slurry, 100 g of the prepared phosphate treatment liquid was entirely introduced into the treatment tank. Subsequently, 6% by mass hydrochloric acid was introduced as needed to control the pH of the phosphate treatment reaction slurry to fall within a range of 2.0±0.1, which was maintained for 40 minutes. The resulting slurry was subjected to suction filtration, dehydration, and vacuum drying to obtain Nd—Fe—N-based anisotropic magnetic powder having a phosphorus compound coating portion. The total magnetic powder thus prepared had a P content of 0.15% by mass. Here, the magnetic powder of Comparative Example 1 and Reference Example 1 was subjected to a line scan as described above, except that the measurement apparatus used was STEM (FEI, model No. Talos F200X, acceleration voltage: 200 kV) and STEM-EDX (system: model No. SuperX, FEI, detector: SDD detector, Bruker) attached to the STEM, and the scan was performed in steps of 0.184 nm.

### Examples 1 and 2

An amount of 1000 g of the Nd—Fe—N-based anisotropic magnetic powder having a phosphorus compound coating portion of Reference Example 1 was gradually heated from room temperature in a gaseous mixture of nitrogen and air (oxygen concentration 4%, 5 L/min) to perform heat treatment at the maximum temperature indicated in Table 2 for eight hours, thereby obtaining oxidized Nd—Fe—N-based magnetic powder.

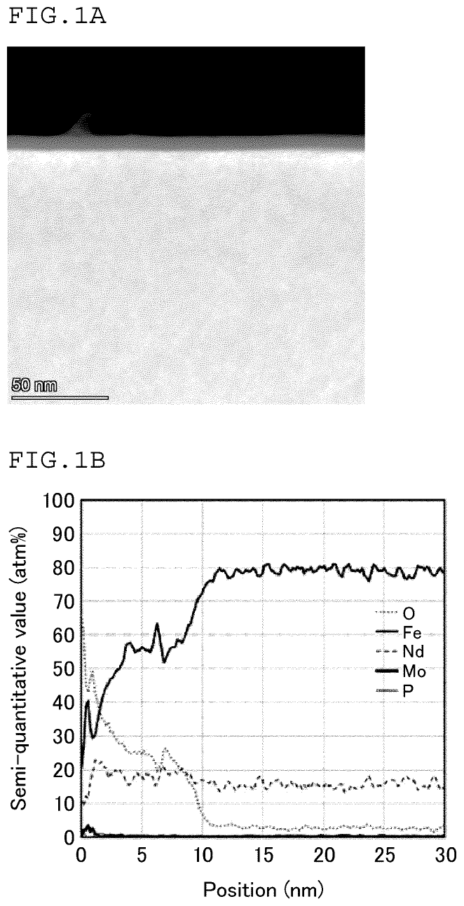

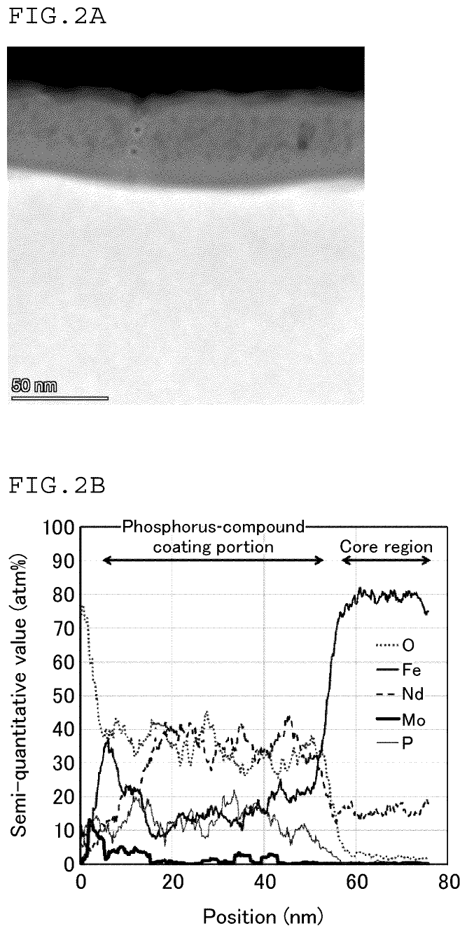

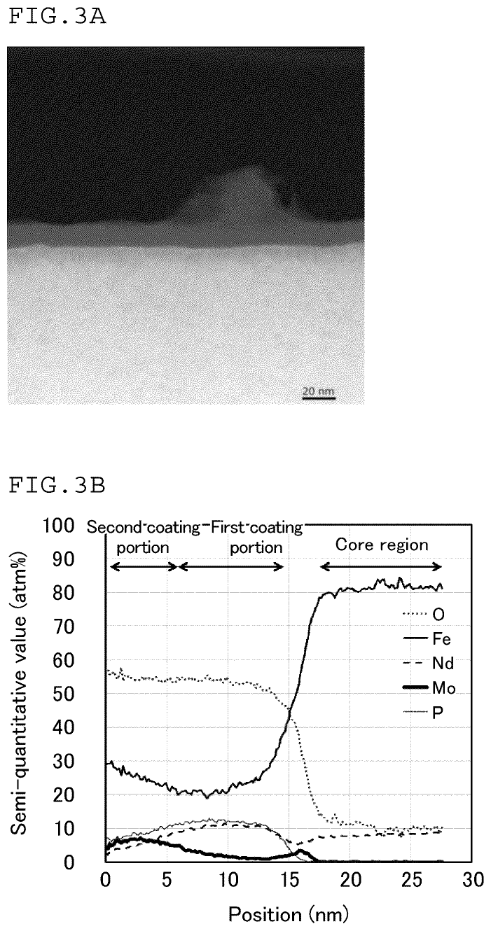

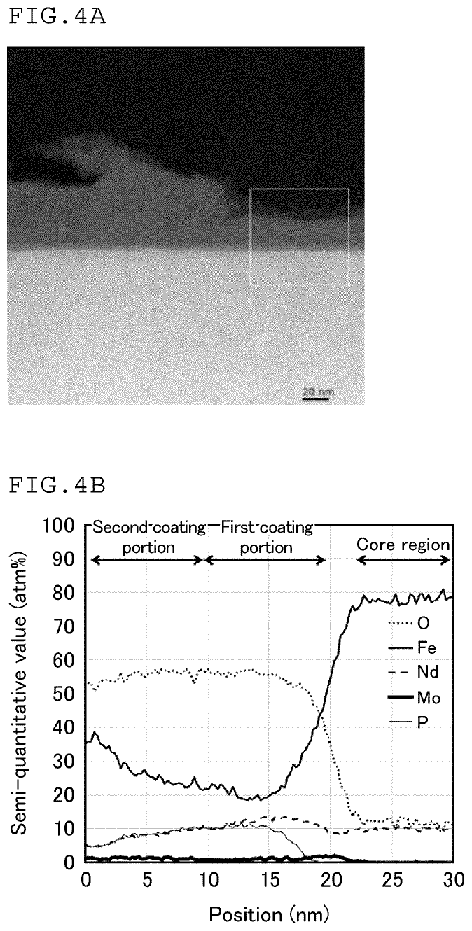

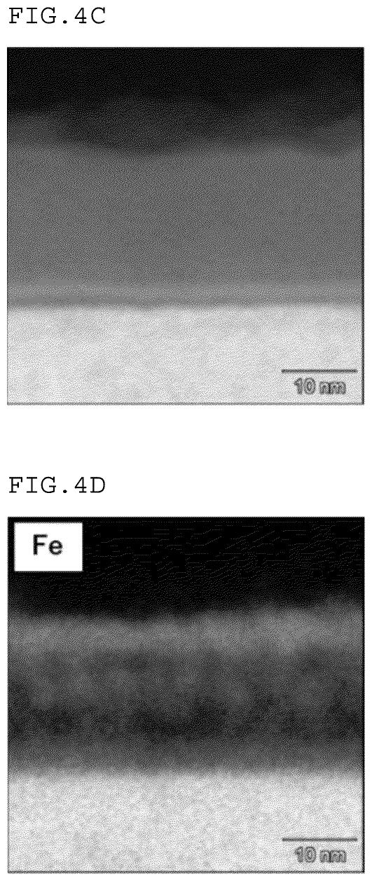

The vicinity of the surfaces of the magnetic powder of Comparative Example 1, Reference Example 1, and Examples 1 and 2 was observed by STEM-EDX to obtain respective STEM images, which are shown in FIG. 1A, FIG. 2A, FIG. 3A, and FIG. 4A, respectively. The respective line scan results of metal elements, P, and O are shown in FIG. 1B, FIG. 2B, FIG. 3B, and FIG. 4B, respectively. Moreover, the atomic concentration (atm %) of Nd in the core region and the atomic concentrations (atm %) of P, Fe, and Nd in the first and second coating portions in Examples 1 and 2 are shown in Table 1.

TABLE 1

| | Average atomic concentration (atm %) | | | | | | |
|---|---|---|---|---|---|---|---|
| | Core | First coating portion | | | Second coating portion | | |
| | Nd | P | Fe | Nd | P | Fe | Nd |
| Example 1 | 8.1 | 11.5 | 23.0 | 10.1 | 8.3 | 25.6 | 5.2 |
| Example 2 | 10.0 | 8.0 | 25.2 | 11.8 | 7.8 | 28.2 | 7.6 |

In FIG. 1A, the gray part in the STEM image of Comparative Example 1 corresponds to an oxygen-rich, P-free film as shown in the line scan, the white part corresponds to rare earth-iron-nitrogen-based magnetic powder constituting a core region, and the black part corresponds to a part outside the magnetic powder.

In FIG. 2A, FIG. 3A, and FIG. 4A, the gray parts in the STEM images of Reference Example 1, and Examples 1 and 2 each correspond to a phosphorus compound coating portion as shown in the line scan, the white parts each correspond to rare earth-iron-nitrogen-based magnetic powder constituting a core region, and the black parts each correspond to a part outside the magnetic powder. The phosphorus compound coating portion of Reference Example 1 had a film thickness of about 60 nm. This coating portion was also found to include a region spanning about 40 nm and containing a larger amount of Nd than the core region, and the atomic concentration of Nd was about 36.6 atm %, which was more than twice the atomic concentration of Nd in the core region. The first coating portions of Examples 1 and 2 had a thickness of about 20 nm. These coating portions each consisted of a first coating portion spanning nm and containing a larger amount of Nd than the core region and a second coating portion containing a larger amount of Fe than the first coating portion. A layer containing at least 1.5 atm % of Mo was present at an interface between the first coating portion and the core region. The concentrations of Nd and P in the second coating portions of Examples 1 and 2 were both less than 9 atm % and were lower than the concentrations in the first coating portion, which were both at least 9 atm %, and the concentrations in the phosphorus compound coating portion of Reference Example 1. It was also confirmed that, in Examples 1 and 2, a third coating portion containing P, Mo, and Nd was partially present outside the second coating portion, as observed at around 15 to 70 nm from the surface of the core region in FIG. 3A and at around 25 to 100 nm from the surface of the core region in FIG. 4A.

Moreover, FIG. 4C shows an enlarged view of the white rectangular region in the STEM image of FIG. 4A. FIG. 4D shows an X-ray image of Fe properties of the white rectangular region in the STEM image of FIG. 4A. As observed in the X-ray image of Fe properties of FIG. 4D, the first coating portion of Example 2 included island-like Fe-rich regions which seemed to have an atomic concentration of Fe comparable to that in the second coating portion. Such regions were not observed in Example 1.

Samples for measuring complex relative permeability at 1 MHz to 1 GHz (toroidal molded products (amount of resin added: 6% by mass) having a density of g/cm³ (Reference Example 1), 5.55 g/cm³ (Comparative Example 1), 5.84 g/cm³ (Example 1), or 5.36 g/cm³ (Example 2)) were prepared from the magnetic powder of Comparative Example 1, Reference Example 1, and Examples 1 and 2 as described above. Table 2 shows the results of evaluation of high-frequency characteristics at 1 MHz to 1 GHz. Examples 1 and 2 had a ratio of θ₁/θ₂ of at least 0.8, where θ₁ represents the phase angle at 100 MHz and 02 represents the phase angle at 13 MHz, indicating excellent efficiency at high frequencies. Also, in Examples 1 and 2, the II′ at 1 MHz was 5.4 and 4.4, respectively, and the μ′ at 1 GHz was 2.5 and 2.8, respectively. Thus, they had a magnetic permeability of at least 2.5 over the range of 1 MHz to 1 GHz. The coated rare earth-iron-nitrogen-based magnetic powder according to embodiments of the present disclosure exhibited a higher efficiency than the powder of Reference Example 1 and Comparative Example 1 due to the effect of electrical insulation between the particles provided by the first and second coating portions.

TABLE 2

| | | | θ(°) | | | |
|---|---|---|---|---|---|---|
| | Phosphorus | Temperature during | 13 MHz | | 100 MHz | |
| | treatment step | oxidation step | (θ₂) | 30 MHz | (θ₁) | θ₁/θ₂ |
| Comparative Example 1 | No | No heat treatment | 42.7 | 30.5 | 26.7 | 0.63 |
| Reference Example 1 | Yes | No heat treatment | 60.9 | 47.6 | 29.1 | 0.48 |
| Example 1 | Yes | 200° C. | 86.0 | 82.9 | 73.7 | 0.86 |
| Example 2 | Yes | 250° C. | 86.3 | 85.4 | 81.7 | 0.95 |

### Example 3 and Comparative Example 2

Nd₂Fe₁₇N₃ magnetic powder that had undergone the phosphorus treatment as in Reference Example 1 and had an average particle size of about 4 μm was prepared in Comparative Example 2. Then, this phosphorus-coated magnetic powder was subjected to the heat treatment as in Example 2 to prepare oxidized Nd—Fe—N-based magnetic powder in Example 3. The imaginary parts of the complex relative permeabilities of the magnetic powder of Comparative Example 2 and Example 3 were measured as described above. Table 3 shows the results.

Here, the densities of the samples of Example 3 were 5.12 to 5.19 g/cm³ (sample 1): 5.14 g/cm³; sample 2): 5.12 g/cm³; sample 3): 5.19 g/cm³), and those of Comparative Example 2 were 5.20 to 5.27 g/cm³ (sample 1): 5.20 g/cm³; sample 2): 5.26 g/cm³; sample 3): 5.27 g/cm³).

As shown in Table 3, Example 3 achieved excellent hyper-high frequency absorption characteristics with an imaginary part μ″ of the complex relative permeability of at least 0.2 in a very broad frequency band of at least 10 GHz but not higher than 0.04 THz. In the coated rare earth-iron-nitrogen-based magnetic powder according to embodiments of the present disclosure, the characteristics of planar magnetocrystalline anisotropic materials, which are different from those of uniaxial magnetocrystalline anisotropic materials, were further improved due to the effect of electrical insulation between the particles provided by the first and second coating portions.

TABLE 3

| | | Temperature | | | |
|---|---|---|---|---|---|
| | Phosphorus | during | | | |
| | treatment | oxidation | μ″ | | |
| | step | step | 10 GHz | 20 GHz | 40 GHz |
| Comparative | No | No heat | 0.151 | 0.051 | 0.026 |
| Example 2 | | treatment | | | |
| Example 3 | Yes | 250° C. | 0.858 | 0.346 | 0.230 |

Embodiments of the present disclosure can provide coated rare earth-iron-nitrogen-based magnetic powder having excellent magnetic field amplification characteristics and hyper-high frequency absorption characteristics. The magnetic powder is suitable as a magnetic material for magnetic field amplification or a magnetic material for hyper-high frequency absorption. The magnetic material for magnetic field amplification or magnetic material for hyper-high frequency absorption may be used as materials for transformers, heads, inductors, reactors, cores (magnetic cores), and yokes used in a high or hyper-high frequency range, which are mainly used in power equipment or information and communication equipment, and high or hyper-high frequency transmitting/receiving elements and antennas for RFID tags, wireless power transfer, etc. The magnetic material for magnetic field amplification or magnetic material for hyper-high frequency absorption may also be used as magnetic materials for microwave elements, magnetostrictive elements, magnetoacoustic elements, magnetic recording elements, and other elements for magnetic field-based sensors such as hall elements, magnetic sensors, current sensors, rotation sensors, and electronic compasses. The magnetic material for magnetic field amplification or magnetic material for hyper-high frequency absorption may also be used as magnetic materials for reducing disturbances caused by unwanted magnetic wave interference such as electromagnetic noise absorbing materials, electromagnetic wave absorbing materials, and magnetic shielding materials, inductor element materials such as denoising inductors, or magnetic materials for removing noise from signals in a high or hyper-high frequency range such as noise filtering materials, etc.

What is claimed is:

1. A coated rare earth-iron-nitrogen-based magnetic powder, comprising:
a core region;
a first coating portion provided outside the core region; and
a second coating portion,
the core region containing R, Fe, and N, where R represents at least one selected from the group consisting of Y, Ce, Pr, Nd, Gd, Tb, Dy, Ho, Er, Tm, Lu, and Sm, and if Sm is present, Sm constitutes less than 50 atm % of a total R content,
the magnetic powder comprising, in an order from the core region,
the first coating portion containing P and R, an average atomic concentration of R in the first coating portion being higher than an average atomic concentration of R in the core region, and the average atomic concentration of R in the first coating portion being not higher than twice the average atomic concentration of R in the core region, and
the second coating portion having average atomic concentrations of P and R lower than average atomic concentrations of P and R, respectively, in the first coating portion and containing Fe.

2. The coated rare earth-iron-nitrogen-based magnetic powder according to claim 1, having a P content that is at least 0.02% by mass but not higher than 4% by mass.

3. The coated rare earth-iron-nitrogen-based magnetic powder according to claim 1,
wherein the first coating portion includes a Fe-rich region.

4. The coated rare earth-iron-nitrogen-based magnetic powder according to claim 1, having a ratio of θ₁/θ₂ that is at least 0.8, where θ₁ represents a phase angle at 100 MHz and θ₂ represents a phase angle at 13 MHz.

5. The coated rare earth-iron-nitrogen-based magnetic powder according to claim 1, having a phase angle θ at 13 MHz that is at least 80°.

6. A magnetic material for magnetic field amplification, comprising the coated rare earth-iron-nitrogen-based magnetic powder according to claim 1.

7. The magnetic material for magnetic field amplification according to claim 6, further comprising a resin.

8. The magnetic material for magnetic field amplification according to claim 6 for use in wireless power transfer.

9. A magnetic material for hyper-high frequency absorption, comprising the coated rare earth-iron-nitrogen-based magnetic powder according to claim 1.

10. A method of producing magnetic powder, the method comprising:
a phosphorus treatment comprising adding an inorganic acid to a slurry comprising: a rare earth-iron-nitrogen-based magnetic powder containing R, Fe, and N, where R represents at least one selected from the group consisting of Y, Ce, Pr, Nd, Gd, Tb, Dy, Ho, Er, Tm, Lu, and Sm, and if Sm is present, Sm constitutes less than 50 atm % of a total R content; water; and a phosphorus-containing substance, to form a phosphorus compound coating portion on the rare earth-iron-nitrogen-based magnetic powder, and
heat-treating the rare earth-iron-nitrogen-based magnetic powder having the phosphorus compound coating portion at a temperature of at least 180° C. but not higher than 350° C. in an oxygen-containing atmosphere.

11. The method of producing magnetic powder according to claim 10,
wherein, in the phosphorus treatment, the inorganic acid is added to adjust a pH of the slurry to at least 1 but not higher than 4.5.
